(19) United States
(12) Patent Application Publication
(10) Pub. No.: US 2024/0037420 A1
(43) Pub. Date: Feb. 1, 2024

(54) Data Analysis and Discovery System and Method

(71) Applicant: ASTN Group, Inc., Austin, TX (US)

(72) Inventors: Rommel MARTINEZ, Bauang (PH); Robert PINEDA, Las Vegas, NV (US)

(21) Appl. No.: 18/144,044

(22) Filed: May 5, 2023

Related U.S. Application Data
(60) Provisional application No. 63/390,152, filed on Jul. 18, 2022.

(51) Int. Cl. G06N 5/022

(52) U.S. Cl. CPC G06N 5/022

(57) ABSTRACT

A system includes a memory storing computer-readable instructions and at least one processor to execute the instructions to receive a query comprising one or more words having a particular sequence, determine a three-dimensional representation of available information associated with the query based on a plurality of information banks, each information bank comprising a layer of available information associated with the query, evaluate the query using the three-dimensional representation of available information associated with the query, the three-dimensional representation of available information having a plurality of terms, each term comprising an identifier, a value, and zero or more related terms, generate a response to the query using the three-dimensional representation of available information, and convert the response to the query into a format for storage.

### CROSS-REFERENCE TO RELATED APPLICATIONS

This application claims the benefit of U.S. Provisional Application No. 63/390,152 filed Jul. 18, 2022, entitled “Data Analysis and Discovery System and Method,” the entire contents of which are incorporated herein by reference.

### BACKGROUND

There are a number of shortcomings associated with traditional artificial intelligence (AI). Traditionally, AI utilizes statistical and probabilistic methods. Large datasets may be used to train a system to solve a particular problem. However, computing devices are only able to produce meaningful results from existing data. In other words, the computing devices suffer from confirmation bias because they are only able to produce results based on what is already known. In one example, a system based on AI may be able to recognize an object such as an animal in a photograph based on images in a library. However, the system would not be able to provide an answer on how to startle the animal. No amount of raw data is ever going to give a system intelligence without addressing the problems of understanding first.

It is with these issues in mind, among others, that various aspects of the disclosure were conceived.

### SUMMARY

The present disclosure is directed to a data analysis and discovery system and method. The system may include a client computing device that communicates with a server computing device to send a query to be processed by the server computing device. The server computing device may receive the query and provide a response using a three-dimensional knowledge graph that can be based on knowledge bases from a variety of sources. As an example, the three-dimensional knowledge graph may be a semantic network of all available data points from the sources.

In one example, a system may include a memory storing computer-readable instructions and at least one processor to execute the instructions to receive a query comprising one or more words having a particular sequence, determine a three-dimensional representation of available information associated with the query based on a plurality of information banks, each information bank comprising a layer of available information associated with the query, evaluate the query using a three-dimensional representation of available information associated with the query, the three-dimensional representation of available information having a plurality of terms, each term comprising an identifier, a value, and zero or more related terms, generate a response to the query using the three-dimensional representation of available information, and convert the response to the query into a format for storage.

In another example, a method may include receiving, by at least one processor, a query comprising one or more words having a particular sequence, determining, by the at least one processor, a three-dimensional representation of available information associated with the query based on a plurality of information banks, each information bank comprising a layer of available information associated with the query, evaluating, by the at least one processor, the query using a three-dimensional representation of available information associated with the query, the three-dimensional representation of available information having a plurality of terms, each term comprising an identifier, a value, and zero or more related terms, generating, by the at least one processor, a response to the query using the three-dimensional representation of available information, and converting, by the at least one processor, the response to the query into a format for storage.

In another example, a non-transitory computer-readable storage medium may have instructions stored thereon that, when executed by a computing device cause the computing device to perform operations, the operations including receiving a query comprising one or more words having a particular sequence, determining a three-dimensional representation of available information associated with the query based on a plurality of information banks, each information bank comprising a layer of available information associated with the query, evaluating the query using a three-dimensional representation of available information associated with the query, the three-dimensional representation of available information having a plurality of terms, each term comprising an identifier, a value, and zero or more related terms, generating a response to the query using the three-dimensional representation of available information, and converting the response to the query into a format for storage.

These and other aspects, features, and benefits of the present disclosure will become apparent from the following detailed written description of the preferred embodiments and aspects taken in conjunction with the following drawings, although variations and modifications thereto may be effected without departing from the spirit and scope of the novel concepts of the disclosure.

### BRIEF DESCRIPTION OF THE DRAWINGS

The accompanying drawings illustrate embodiments and/or aspects of the disclosure and, together with the written description, serve to explain the principles of the disclosure. Wherever possible, the same reference numbers are used throughout the drawings to refer to the same or like elements of an embodiment, and wherein:

FIG. 1 is a block diagram of a data analysis and discovery system according to an example of the instant disclosure.

FIG. 2 shows a volume data structure used by the data analysis and discovery system according to an example of the instant disclosure.

FIG. 3 shows frame burying according to an example of the instant disclosure.

FIG. 4 shows frame banishing according to an example of the instant disclosure.

FIG. 5 shows horizontal volume binding according to an example of the instant disclosure.

FIG. 6 shows vertical volume binding according to an example of the instant disclosure.

FIG. 7 shows volume destructuring according to an example of the instant disclosure.

FIG. 8 shows interconnected volume blocks according to an example of the instant disclosure.

FIG. 9 shows basic and extended capsules according to an example of the instant disclosure.

FIG. 10 shows sub-capsules according to an example of the instant disclosure.

FIG. 11 shows constants and overlays according to an example of the instant disclosure.

FIG. 12 shows a block diagram of a server computing device of the data analysis and discovery system having a data analysis and discovery application according to an example of the instant disclosure.

FIG. 13 is another block diagram of the data analysis and discovery system according to an example of the instant disclosure.

FIG. 14 is an example of a graphical user interface (GUI) of the data analysis and discovery system according to an example of the instant disclosure.

FIG. 15 is another example of a GUI of the data analysis and discovery system according to an example of the instant disclosure.

FIG. 16 is another example of a GUI of the data analysis and discovery system according to an example of the instant disclosure.

FIG. 17 is another example of a GUI of the data analysis and discovery system according to an example of the instant disclosure.

FIG. 18 shows a first example of a visualization of storing information according to an example of the instant disclosure.

FIG. 19 shows a second example of a visualization of storing information according to an example of the instant disclosure.

FIG. 20 shows a third example of a visualization of storing information according to an example of the instant disclosure.

FIG. 21 shows a fourth example of a visualization of storing information using bindings according to an example of the instant disclosure.

FIG. 22 shows a fifth example of a visualization of storing information using anchors according to an example of the instant disclosure.

FIG. 23 shows a sixth example of a visualization of storing information using layers according to an example of the instant disclosure.

FIGS. 24-54 illustrate diagrams associated with extended Backus-Naur form (EBNF) providing a formal description of a formal language associated with the data analysis and discovery system according to an example of the instant disclosure.

FIG. 55 is a flowchart of a method of receiving a query and providing results associated with the query according to an example of the instant disclosure.

FIG. 56 shows an example of a system for implementing certain aspects of the present technology.

### DETAILED DESCRIPTION

The present invention is more fully described below with reference to the accompanying figures. The following description is exemplary in that several embodiments are described (e.g., by use of the terms “preferably,” “for example,” or “in one embodiment”); however, such should not be viewed as limiting or as setting forth the only embodiments of the present invention, as the invention encompasses other embodiments not specifically recited in this description, including alternatives, modifications, and equivalents within the spirit and scope of the invention. Further, the use of the terms “invention,” “present invention,” “embodiment,” and similar terms throughout the description are used broadly and not intended to mean that the invention requires, or is limited to, any particular aspect being described or that such description is the only manner in which the invention may be made or used. Additionally, the invention may be described in the context of specific applications; however, the invention may be used in a variety of applications not specifically described.

The embodiment(s) described, and references in the specification to “one embodiment”, “an embodiment”, “an example embodiment”, etc., indicate that the embodiment(s) described may include a particular feature, structure, or characteristic. Such phrases are not necessarily referring to the same embodiment. When a particular feature, structure, or characteristic is described in connection with an embodiment, persons skilled in the art may effect such feature, structure, or characteristic in connection with other embodiments whether or not explicitly described.

In the several figures, like reference numerals may be used for like elements having like functions even in different drawings. The embodiments described, and their detailed construction and elements, are merely provided to assist in a comprehensive understanding of the invention. Thus, it is apparent that the present invention can be carried out in a variety of ways, and does not require any of the specific features described herein. Also, well-known functions or constructions are not described in detail since they would obscure the invention with unnecessary detail. Any signal arrows in the drawings/figures should be considered only as exemplary, and not limiting, unless otherwise specifically noted. Further, the description is not to be taken in a limiting sense, but is made merely for the purpose of illustrating the general principles of the invention, since the scope of the invention is best defined by the appended claims.

It will be understood that, although the terms “first,” “second,” etc. may be used herein to describe various elements, these elements should not be limited by these terms. These terms are only used to distinguish one element from another. Purely as a non-limiting example, a first element could be termed a second element, and, similarly, a second element could be termed a first element, without departing from the scope of example embodiments. As used herein, the term “and/or” includes any and all combinations of one or more of the associated listed items. As used herein, the singular forms “a”, “an,” and “the” are intended to include the plural forms as well, unless the context clearly indicates otherwise. It should also be noted that, in some alternative implementations, the functions and/or acts noted may occur out of the order as represented in at least one of the several figures. Purely as a non-limiting example, two figures shown in succession may in fact be executed substantially concurrently or may sometimes be executed in the reverse order, depending upon the functionality and/or acts described or depicted.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Aspects of a data analysis and discovery system and method includes a client computing device that communicates with a server computing device to send a query to be processed by the server computing device. The server computing device may receive the query and provide a response using a three-dimensional knowledge graph that can be based on knowledge bases from a variety of sources. As an example, the three-dimensional knowledge graph may be a semantic network of all available data points from the sources.

The vast majority of the ways artificial intelligence are being approached now is through statistical and probabilistic methods. Large data sets are being used to train systems to emulate a narrow subset of the way humans think and solve problems. These intelligent machines are only able to produce meaningful results from existing data. There are systems that are able to render faces of humans that do not exist in real life. In addition, there are systems that learn how to punch and kick. The common problem with such systems is that they rely on existing data in order to simulate learning new skills. The issue that arises from that this is confirmation bias—the systems are only able to produce results based on what they already knew. Humans would only like to believe that they are producing something completely novel because they are conditioned accept them beforehand. Truly unique composition is absent.

The way humans learn to communicate using languages and subsequently understanding them, however, is different. As an example, for a human child, one doesn't teach the parts of speech nor the relationship of the language components to them. The child learns to communicate using a gradual learning approach—one that involves continual exploration. A child uses the constant feedback loop between them and another communicator. By having a rapid and fluid loop, a child's association with sounds becomes associative and causative with the environment that they are experiencing and perceiving. In a similar vein, if you were teaching a child how to open a door, you would not open the door for the child and then describe at length how the door looked when it was open. On the contrary, you would teach how to turn the doorknob so that the child could open the door.

It can be easier to make a computer display adult-level performance when given tasks like solving board games, but it is impossible to make them display the abilities of a typical one-year-old when handling problems about perception and seeing the world around them from a zeroth position. The main lesson of thirty-five years of AI research is that the hard problems are easy and the easy problems are hard. The mental abilities of a four-year-old that are taken for granted-recognizing a face, lifting a pencil, walking across a room, answering a question—in fact solve some of the hardest engineering problems ever conceived.

Contemporary Natural Language Processing (NLP) systems work by using training models and existing data sources to teach a machine what are the Parts of Speech (PoS) and Universal Dependencies (UD). Such systems are able to tag an input text what are nouns, verbs, etc. because it already knows about them, beforehand. By ingesting huge corpora and comparing the results of analyzing them with another data set, these systems became good at identifying such things.

Because of the way such NLP systems work, a significant majority of them are designed to only handle the most common spoken languages—English, Arabic, Chinese, French, German, and Spanish. Corpora for these languages are not only abundant but also have a long history. Because of this, it is easier to create training models. The problem, however, is that text processing becomes limited to data that is available. This implies that a system trained to handle and recognize an X set of languages, will have difficulties and produce inaccurate results when tasked to handle languages outside of those sets.

Another prevalent issue with NLP systems now is whether they truly understand the text or they have merely run its input through a processor. To truly understand, in this context, means to have the comprehension skills of an average adult human. It also implies that an equivalent mental model is created based on the inputs that it has received. The problem is particularly evident with the Chinese room argument. It supposes that a closed room exists with two slots on the outside—one for questions and another for answers. A questioner would slide in a piece of paper that contains Chinese text, and on the other slot comes out the answers. Inside the room lives an operator who doesn't understand Chinese, only understands English, and has a manual for written in English for matching questions to answers. The manual says that if the operator sees Chinese characters that match a certain shape and sequence, the operator would respond with the specific matching Chinese text found in the manual, using the answer slot on the room. From the questioner's standpoint, whatever is inside the room possesses the ability to both understand and speak Chinese.

As an example, there was Sophia, the robot that was developed by Hanson Robotics under the guidance of Ben Goertzel. When the robot debuted, it was made to appear that it possessed human-level intelligence and that it would be able to converse like a human to another human. It was also shown that it was able to convey facial expressions and body gestures, to go along with the speech. It was soon discovered that it is not any different from a marionette—human operators were necessary in order for it to operate “correctly.” For whatever it is worth, it is a chatbot with a face.

Several morphological systems have been designed in the past decade. The systems approach linguistics via the textual representations of language and that text is most often dissected into parts and how they relate to each other. Systems such as CoreNLP and spaCY can handle linguistic interactions using morphological syntactic analysis of corpora. In addition to that, they have strong a dependence on ontological databases of what constitutes components. These systems are not able to operate inside a vacuum. They need information stored elsewhere in order to begin processing knowledge. They need seed knowledge.

Most, if not all, language systems rely on using information that has been secured beforehand—frontloading. They work exclusively using the answer model, wherein they already know the answer before the question has been asked. There is no process of inquiry. There is no curiosity. They display a certain degree of intelligence, but this is mostly due to the confirmation bias of humans, making us believe that they indeed possess cognizance, even when it is not present.

According to Noam Chomsky, humans have the predisposition to learn languages, that is, the ability to learn languages is encoded in our brains long before we are born. The hypotheses of Chomsky state that the reason why humans, especially children, are able to pick up language easily is that our brains have already been wired to learn it. He argues that even without the basic rules of grammar, our brains are still well adapted to learn them along the way.

However, it is possible to challenge the positions of Chomsky about the innateness of learning languages. By resigning to the idea that language can only be learned innately, it is possible to lose the ability and the curiosity to understand language from its most primary underpinnings. When committed to the idea that there is only one exclusive, golden way to learn languages, other possibilities of effectively capturing languages and properly systematizing and controlling its very nature are eliminated. Chomsky's Language Acquisition Device (LAD) can be synthetically created and be installed to an empty artificial brain.

One of the key questions to raise with language learning is: can it be sped up? Normally, it would take time for a child to acquire a basic language skillset before they can communicate with the immediate people around them. Now, can a machine learn languages faster than a child? In order for AI systems to even remotely approach the A-consciousness of a two-year-old child, it must be able to communicate bidirectionally with the external world. It must be able to pose questions. It must be curious on its own. Modern AI systems cannot and do not ask questions to humans or to fellow machines.

It is considerably more difficult to build a synthetic brain from scratch or to simulate the concept of a mind that can readily interact with the world around it—much like a four-year old child, a priori—than to provide a means for a learning system to interact with the world—or a subset of it—physically. Physical in this sense means being able to use sensory inputs to validate existing knowledge, capture new data, to be familiar with new inputs, and stash unknown things for later processing.

A machine now would be happy to chuck truckloads of data and assign meaning to them. The problem with this approach, however, is that the meaning does not come from the machine itself but rather comes precomposed from human processing. It may be able to categorize and differentiate dogs from cats, but intrinsically, it doesn't know what they are beyond their representations as images stored on a computer system. A system based on machine learning may be able to recognize a cat in a picture, but when asked what happens when you startle a cat, it fails miserably.

It is believed that that a machine cannot attain human-level intelligence without having some kind of body that interacts with the world. In this view, a computer sitting on a desk, or even a disembodied brain growing in a vat, could never attain the concepts necessary for general intelligence. Instead, only the right kind of machine—one that is embodied and active in the world—would have human level intelligence in its reach.

With this in mind, it is possible to construct sophisticated systems using initial embodied entities, who are going to interact with the world, like humans, but to a significantly less detailed resolution, which has the ability to transfer knowledge to disembodied systems one of its goals. In that way, embodied systems will function as both learning scouts and learning individuals. In contrast to human learning, the transfer of memes from a parent to a child takes a significantly large amount of time because of the lack of bandwidth in the brain of a child. In addition to that, the child still has to perceive the world around them, in person, to learn new things.

With that in mind, the embodied-disembodied pairing is proposed because it is possible to take advantage of the advances in technology to transfer information unidirectionally, rapidly. Using this approach, a disembodied system may not need to interact with the world in order to process information because an embodied entity is already doing the processing of raw sensory physical inputs from the world, for the disembodied one.

In trying to approach one of the key problems of AGI A—consciousness, adaptability, and comprehension—it is tempting to implement all the features that allow a human to interact with other humans and with the rest of the world. Capabilities such as vision, hearing, olfaction, sense of taste, sense of touch, and mobility all contribute to enabling a human to acquire and share knowledge, test hypotheses, conduct experiments, make observations, and travel to new places. Because of these features, it makes learning very fast and natural for humans. It also forms the cornerstones of A-consciousness and reasoning. This is in contrast to handling the more difficult problems of AGI—phenomenal consciousness (P-consciousness), which deals with moving, colored forms, sounds, sensations, emotions and feelings with our bodies and responses at the center.

It is worth noting, however, that even if some senses are not available, a human can still mature and have sound modes of reasoning. If a man is blind at birth or becomes blind in the course of his life, it is still possible for him to practice strong reasoning, human-to human interaction, and curiosity. If a man loses the sense of smell and hearing, he is still able to make use of the other senses to interact with the world. There are capabilities, however, that one must absolutely have in order to have a functional life, like sense of touch and mobility.

A hypothetical minimal brain would contain only the minimum processing requirements in order to process touch and execute mobility. With the sense of touch, an embodied system would be able to sense physical objects and create maps of them in its brain. With the sense of touch, an embodied system would be able to correctly qualify the properties of physical objects around him. With mobility, even if an embodied system with bipedal locomotion loses a leg, it will still be able to process inputs in its environment if it balances on one leg or move with the assistance of a tool.

Inside a virtual reality (VR) world, a disembodied system would be stopped from running if it hits a wall, not because the wall has innate qualities that prevent things from passing through it, but because of predetermined rules inside that world. An embodied system with a minimal brain would be able to explore the world and see that if it tries to walk past a wall, it is stopped. This is similar in concept to a robotic vacuum wherein it creates a map of its environment by learning what it can pass through and what it cannot.

Instead of waiting for the outstanding problems of sensory processing to be solved, a minimal brain can already be designed, whose primary attributes are having the minimal amount of sensory processors to be able to interact with the world as embodied systems. The design of a minimal brain is that it should be able to accept new ways of processing input—such as strong Computer Vision (CV)—in the future.

One of the most important components of current AI systems is data and how they are being dissected, processed, and analyzed. How data is analyzed between intelligent systems is what makes the difference. Some take the approach of pouring data into a pot, stirring it, and hoping that whatever comes out of it would make sense to a human. Others concoct fancy rules into how it must be interpreted, taking the opposite approach. The systems discussed herein takes inspirations from both camps but adds the flexibility of making the knowledge that it has acquired to be malleable.

Currently, AI systems have training models that will try to cover all possible present and future scenarios. It does so via the use of neural networks and variations of it. Such networks are commonly observed with machine learning (ML), wherein training models are used to build a network. Usually, ML requires a lot of data to create a reasonable system to perform well. This approach is already being employed in fields from agriculture to speech recognition. ML excels at developing statistical models. However, one of the most common problems of ML is that it is unable to cope with situations that it has not been trained with. There have been numerous incidents of self-driving cars that crashed into pedestrians, trees, and overturned trucks. Black swans are ignored.

Another form of an AI system that is still in use today is Good Old Fashioned Artificial Intelligence (GOFAI). One approach of GOFAI is through the use of symbols to represent things and concepts. Trees and nodes of connections are formed to create the relationships between these symbols. In addition to connections, properties of symbols can be encapsulated inside such symbols. GOFAI excels when logic and reasoning can be readily applied to a problem domain. However, GOFAI fails when the rules that are created are not sufficient to describe a scenario. It fails when relationships between symbols cannot be determined beforehand.

Finally, a less popular approach to AI that is still in use are robots using human brain simulation. They mimic, to a certain degree, how the nervous system works. It works through the use of sensors to detect temperature, hardness, obstacles, light, and odor. These systems performed well when navigating rooms and performing factory assembly tasks. Soon after, it was realized that the intelligence that these robots possessed were fairly limited and only performed one-way tasks.

Due to limitations of existing approaches to artificial intelligence, and the way it is desired to handle the things where there are no elegant solutions, yet, the systems and methods discussed herein utilize alternative methods to bridge the gaps between symbolic, sub-symbolic, robotic, and statistical learning. In order to resolve the difficulties present in these systems, it was imperative to determine whether the core concepts of each can be carried over to a new system, and whether they can be forged to work together.

Data can be roughly divided into two camps: structured and unstructured. It is still a subject of debate, to this day, what should be constituted as such. Most researchers would agree, however, that structured data are the ones with a uniform set of structures and can be parsed without too many ambiguities. Examples of structured data would be key-value stores, spreadsheets, and tabular data. Unstructured data, on the other hand, are the ones without a clear form, or more specifically, ones whose form cannot be easily represented in a structured manner. Examples of unstructured data are narrative text, images, and video.

The vast majority of unstructured data are still being handled through brute force, via one or more forms of neural networks. Data is still processed with human evaluators at the end, which unintentionally gives it a bias towards human inclinations—it may make sense to humans but not necessarily to other forms of life that may also exhibit intelligence. When neural networks are used to handle natural languages, the language constructs are nothing but just a mixed soup of ingredients to the system. NLU systems have no intrinsic knowledge of the information that they are processing.

With a plethora of raw data at our disposal, it becomes tempting to use these vast amounts of data to attack the language problem. The problem with this is that it is the wrong problem that is being attacked. What should be the focus is the comprehension problem. No amount of raw data is ever going to give a supposedly intelligent system intelligence without addressing the problems of understanding first.

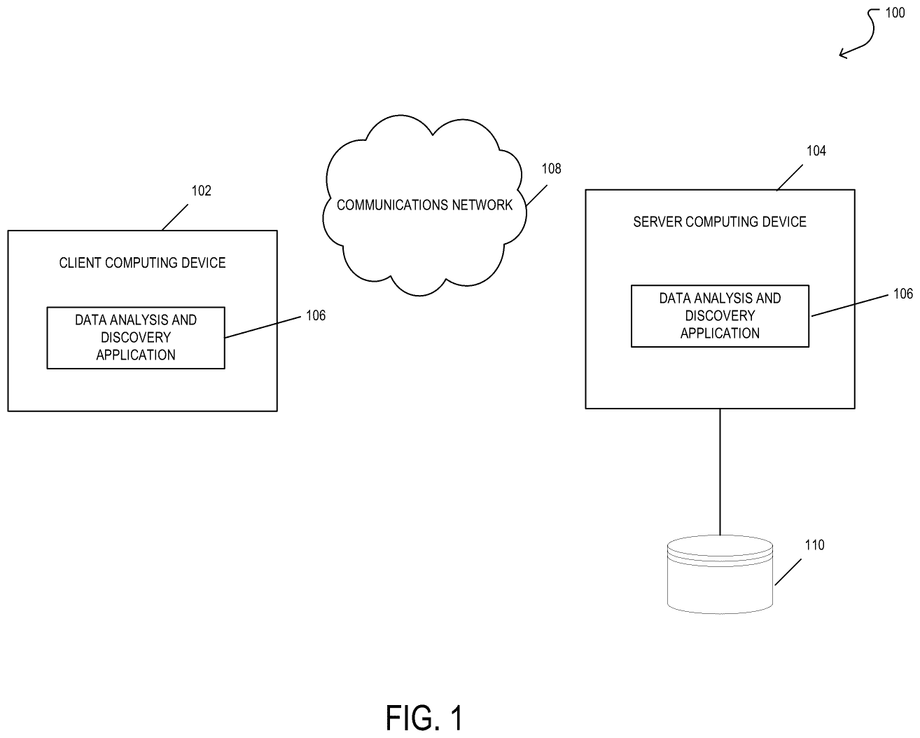

FIG. 1 is a block diagram of a data analysis and discovery system 100 according to an example of the instant disclosure. As shown in FIG. 1, the system 100 may include at least one client computing device 102 and at least one server computing device 104. The at least one server computing device 104 may be in communication with at least one database 110.

The client computing device 102 and the server computing device 104 may have a data analysis and discovery application 106 that may be a component of an application and/or service executable by the at least one client computing device 102 and/or the server computing device 104. For example, the data analysis and discovery application 106 may be a single unit of deployable executable code or a plurality of units of deployable executable code. According to one aspect, the data analysis and discovery application 106 may include one component that may be a web application, a native application, and/or an application (e.g., an app) downloaded from a digital distribution application platform that allows users to browse and download applications developed with software development kits (SDKs) including the APPLE® iOS App Store and GOOGLE PLAY®, among others.

The data analysis and discovery system 100 also may include one or more data sources that store and communicate data from at least one database 110. The data stored in the at least one database 110 may be associated with the data analysis and discovery application 106 including queries received by the data analysis and discovery application 106 as well as responses to the queries, among other information.

The at least one client computing device 102 and the at least one server computing device 104 may be configured to receive data from and/or transmit data through a communication network 108. Although the client computing device 102 and the server computing device 104 are shown as a single computing device, it is contemplated each computing device may include multiple computing devices.

The communication network 108 can be the Internet, an intranet, or another wired or wireless communication network. For example, the communication network may include a Mobile Communications (GSM) network, a code division multiple access (CDMA) network, 3^{rd} Generation Partnership Project (GPP) network, an Internet Protocol (IP) network, a wireless application protocol (WAP) network, a Wi-Fi network, a Bluetooth network, a near field communication (NFC) network, a satellite communications network, or an IEEE 802.11 standards network, as well as various communications thereof. Other conventional and/or later developed wired and wireless networks may also be used.

The client computing device 102 may include at least one processor to process data and memory to store data. The processor processes communications, builds communications, retrieves data from memory, and stores data to memory. The processor and the memory are hardware. The memory may include volatile and/or non-volatile memory, e.g., a computer-readable storage medium such as a cache, random access memory (RAM), read only memory (ROM), flash memory, or other memory to store data and/or computer-readable executable instructions. In addition, the client computing device 102 further includes at least one communications interface to transmit and receive communications, messages, and/or signals.

The client computing device 102 could be a programmable logic controller, a programmable controller, a laptop computer, a smartphone, a personal digital assistant, a tablet computer, a standard personal computer, or another processing device. The client computing device 102 may include a display, such as a computer monitor, for displaying data and/or graphical user interfaces. The client computing device 102 may also include a Global Positioning System (GPS) hardware device for determining a particular location, an input device, such as one or more cameras or imaging devices, a keyboard or a pointing device (e.g., a mouse, trackball, pen, or touch screen) to enter data into or interact with graphical and/or other types of user interfaces. In an exemplary embodiment, the display and the input device may be incorporated together as a touch screen of the smartphone or tablet computer.

The server computing device 104 may include at least one processor to process data and memory to store data. The processor processes communications, builds communications, retrieves data from memory, and stores data to memory. The processor and the memory are hardware. The memory may include volatile and/or non-volatile memory, e.g., a computer-readable storage medium such as a cache, random access memory (RAM), read only memory (ROM), flash memory, or other memory to store data and/or computer-readable executable instructions. In addition, the server computing device 104 further includes at least one communications interface to transmit and receive communications, messages, and/or signals.

As an example, the client computing device 102 and the server computing device 104 communicate data in packets, messages, or other communications using a common protocol, e.g., Hypertext Transfer Protocol (HTTP) and/or Hypertext Transfer Protocol Secure (HTTPS). The one or more computing devices may communicate based on representational state transfer (REST) and/or Simple Object Access Protocol (SOAP). As an example, a first computer (e.g., the client computing device 102) may send a request message that is a REST and/or a SOAP request formatted using JavaScript Object Notation (JSON) and/or Extensible Markup Language (XML). In response to the request message, a second computer (e.g., the server computing device 104) may transmit a REST and/or SOAP response formatted using JSON and/or XML.

The data analysis and discovery system 100 may include a collection of intelligent agents for information augmentation that uses novel approaches and methods for data analysis and discovery. The system may have a number or components or modules known as Veda, Vera, Vega, Vela, and Xavier discussed herein, among others.

The system 100 provides discovery and exploration designed to be used by analysts and engineers. As a service, the system 100 performs information augmentation, dynamic analysis, and automated introspection on data.

The system 100 can convert existing (and new) data into knowledgebases, turning stale, unindexed data into live libraries of knowledge sources.

Rationale

When searching for information, the results returned can be superficially related to a query. But, most of the time, a user may not be aware that there are already hints of information buried deep down in files and databases. A user may not even know that the hints of information are present. The system allows a user to make those kinds of discovery, so that it will be able to perform information augmentation.

Key Features

When a user loads data sources—spreadsheets, documents, folders—the system 100 analyzes the data sources and creates intricate networks of information. Through information augmentation, new information can be bound to the existing information, compounding the databases.

When an analyst uses the system 100, the analyst can either search for information related to known information or she can obtain insights about the database. For example, if the active domain that the analyst is in is related to airplane landing parts, the analyst can search information about tires. In addition to obtaining compound information about tires, the analyst would also get information about wheels, suspension, and brakes, because the system 100 is able to determine the other domains that are related to the active domain.

The system 100 excels at turning static, flat data into dynamic, searchable, and indexable information. Existing data sources like spreadsheets can be easily imported to the system 100 turning them into live knowledgebases.

Operating Modes

The system 100 operates in two basic modes: active and passive. In the active mode, the user has direct influence over what kinds of connections and relationships the system 100 makes. In this mode the user can provide overrides as to what kinds of information repositories the system creates and manages. When the system 100 is running in passive mode, it searches the entire network looking for new connections and relationships to make.

System Availability

Desktop Application

The data analysis and discovery application can be a desktop application. The application can receive data files, process the data files, and indicate to the user available operations that can be performed on data files, including, but not limited to giving insights and analysis.

The desktop application also can integrate with already-existing apps and systems. The desktop application is able to take in the output of an app, and produce data analysis and discovery output. Alternatively, the application can receive or take in the output of an application, perform processing and analysis on the output, then produce output for another application in a pipeline.

The desktop application is designed to run both in offline and online modes. The data analysis and discovery application can utilize databases common to industries and additional databases specific to your industry.

Web Application Programming Interface (API)

When used via the Web API, a client connects to the data analysis and discovery application 106, e.g., Valmiz, and makes requests and receives results. A client in this context could mean an automated client or one that is operated by a human user. The API also allows clients to connect to any of the subsystems to perform specific tasks for that direction.

When communicating with a human machine interface, e.g., Xavier, a user can send queries and get back information blocks as a result. The basic form of a query is a sequence of words, whether inputted via plain text or voice. The result is a conglomerate of data having a JSON format to maximize systems compatibility.

When communicating with a metadata module, e.g., Vera, a user can send Vera terms for evaluation. The result are terms that reflect the result of the evaluation process. Communicating with Vera also triggers indirect communication with a data ingestion module, e.g., Veda, since all Vera terms go to Veda for further processing.

When communicating with the data ingestion module, e.g., Veda, a user interacts directly with the core AI system in a fine grained manner. This allows direct execution of commands like volume and registry management, searching for specific data stores, and other operations like data filtration and file ingestion.

When communicating with a data gathering module, e.g., Vela, a user is allowed to control the parameters that Vela is using for collecting data across the internet, intranets, local drives, and other data sources. A user is given the ability to extract raw information from the data that it has collected, yielding information like origin of data, timestamps, and link dumps.

Deployment Versions

The data analysis and discovery application can address the needs of different industries and markets. Below is a list of the uses of the data analysis and discovery application: General Election, Election Security, Healthcare Services Solutions, Valmiz Pharmaceutical Technology Quality Assurance, Cybersecurity Audit Readiness, Aerospace, Self Driving Vehicle, Wireless Energy, Payment Solutions, and Education, among others.

Information Radius

When a specific piece of information is connected to other pieces of information, they can form a network. Each of those connecting nodes of information are in turn connected to more pieces of information. Then, there's a point, e.g., a threshold, wherein an information branch has very few connecting nodes, relative to the starting node.

When collecting the information together, the information can form a compound object—a collective network that has both direct and indirect paths to a parent node. The amount of information that can be accessed from the center, all the way to the edge is known as an information radius. The radius sets a perimeter on what can be considered within a context of the central idea.

When able to compute the information radius of any idea, it is possible to effectively contain and aggregate information into a single globular unit. This unit can then interact with other such units to form super networks.

Information Distance

In principle, every idea, every object, is connected to each other. A ripe mango is connected to a truck, in a way that a truck has capabilities of transporting ripe mangoes from the farm to the market. The amount of steps needed to connect ripe mangoes to trucks is what's called the information distance.

The smaller the information distance of idea A to idea B, the less contextual information they share. The bigger the information distance is, the more contextual information they share, derived both actively and passively.

By being able to compute information distances, it is possible to determine the amount of information traversal that is needed to properly contextualize them. It also provides insights about all the other related information between two points, which may be of significant interest to the examiner.

Augmentive Intelligence

Having the knowledge necessary to perform a task is the key to doing the task efficiently. Having more knowledge at your disposal, however, draws the line between being able to do something in a month versus being able to do it in two days.

Acquiring that kind of knowledge, however, is both hard and time consuming. The key principles are already there to execute the tasks. The ethics of proper human decision making are also there. New ways are needed that allows us to do the same tasks, but in a significantly more efficient way. Instead of using shovels to dig a construction site, it is possible to use excavators.

Augmentive intelligence presents toolkits that augments your existing ideas, workflows, and pipelines, with knowledge and expertise from many different knowledge domains while putting a human in the center to supervise operations.

When dealing with the problems of information representation, it is important to determine what are the key data structures and algorithms to use. In software domains like conventional relational and key-value databases, compression, image processing, etc., it can be relatively easy to pick a data structure that is already in widespread use. In those industries, the high ceilings are relatively within reach. In AI, however, it is detrimental to use data structures that are not custom-fit to handle the problems within that domain.

In trying to discover what should be the key qualities of a novel data structure that will support the kinds of capabilities that are desired to have, the following questions are to be answered:

| | |
|---|---|
| | How is information represented? |
| | How is it structured? |
| | What kinds of data can be encapsulated? |
| | What kinds of operations are possible? |
| | What are its key features? |
| | What distinguishes it from other approaches? |
| | How can it be used? |
| | Are there systems that already implement it? |
| | The following terms noted below are discussed herein. |
| | item (n): the smallest unit of information, e.g., (“foo” “bar”) |
| | feed (n): raw groups of items, e.g., ((“foo” “bar”) (“qux” “quux”)) |
| | pool (n): an instantiated item |
| | volume (n): an instantiated feed; more accurately, an index to entries |
| | frame (n): a pool, unit, or volume |
| | registry (n): a particular group of entries and volume in the universe |
| | store (n): a volume or a registry |
| | universe (n): the top-level encapsulating data structure |
| | template (n): a source registry |
| | wall (n): the longest/largest volume in a registry |
| | forge (v): to instantiate a frame then add it to the registry |
| | node (n): a part of a pool |
| | selector (n): a function used to refine searches |
| | test (n): the predicate used to test matches between pool values |
| | query (n): an integer or a string |
| | offset (n): the distance from the start of a volume to a specific pool |
| | unit (n): a frame that is used to resize volumes and set alignments |
| | bury (v): to make a pool hidden |
| | link (n): a two-way connection between frames |
| | link (v): to create such a connection |
| | unbury (v): the inverse of bury |
| | unlink (v): to remove the links of a frame |
| | blank (v): to the value of a pool to nil |
| | deregister (v): to remove a pool from a register |
| | void (n): a kind of registry where banished entries go. |
| | banish (v): to bury, send to a void, and deregister a pool |
| | bind (v): to connect a pool to another pool in another volume |
| | column (n): a section of a pool which corresponds to a node |
| | value (n): any string value |
| | header (n): a CSV header extracted from a file or specified by the user |
| | header-specifier (n): an item from the header that specifies a node |
| | constraint (n): a header-specifier, or integer index |
| | specifier (n): a list of header-specifier and value |
| | indicator (n): a string that specifies a volume or a registry |
| | blob (n): an object that contains the original data of text, and the filtered, processed |
| version | |
| | term (n): a constraint with a meta-character to indicate the kind of operation |

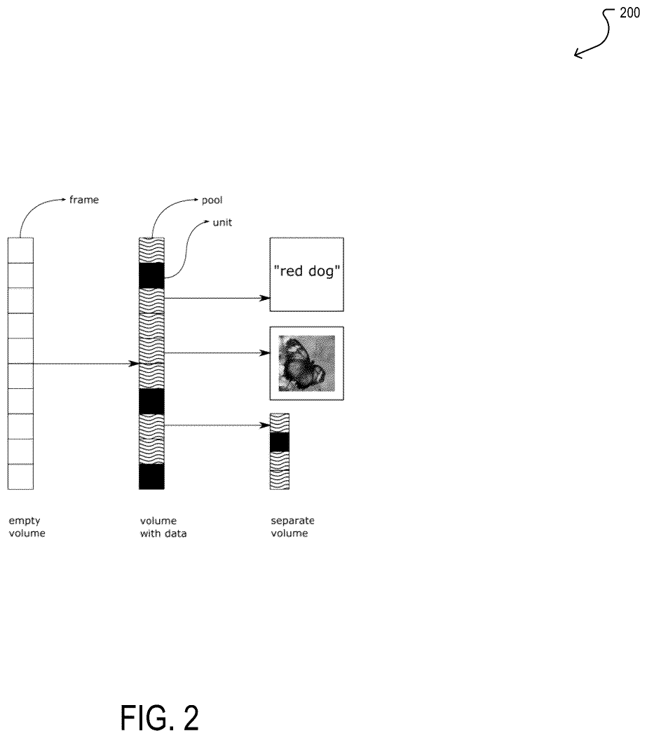

As shown in FIG. 2, volumes 200 are novel data structure groups that make it possible to perform computations, analysis, and discovery, in a way that was not easy to do before. With volumes come the concepts of frames, pools, units, and cells. Together they make up microcosms within registries and universes.

Volumes 200 are represented as semi-contiguous connections of frames, which could either be pools or units. A frame is a container and pointer that contains navigational information in a volume. A pool is a frame that contains a value, while a unit is a frame that doesn't contain a value. A “value” in this sense may be any kind of data, a pointer to another frame, or a pointer to another volume. This is the container property of volumes. Volumes can be disassembled and reassembled in different configurations including, but not limited to: frame burying—the ability to temporarily make a frame inaccessible in a volume

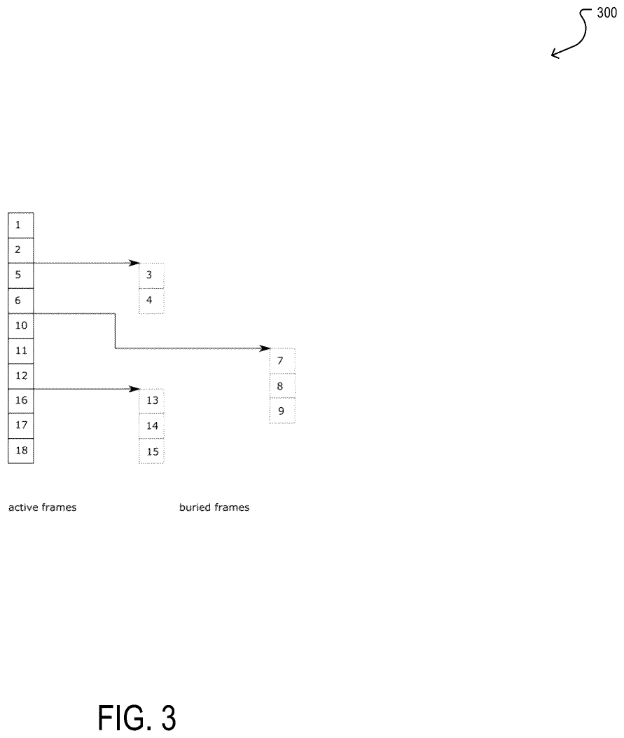

FIG. 3 shows frame burying 300 according to an example of the instant disclosure.

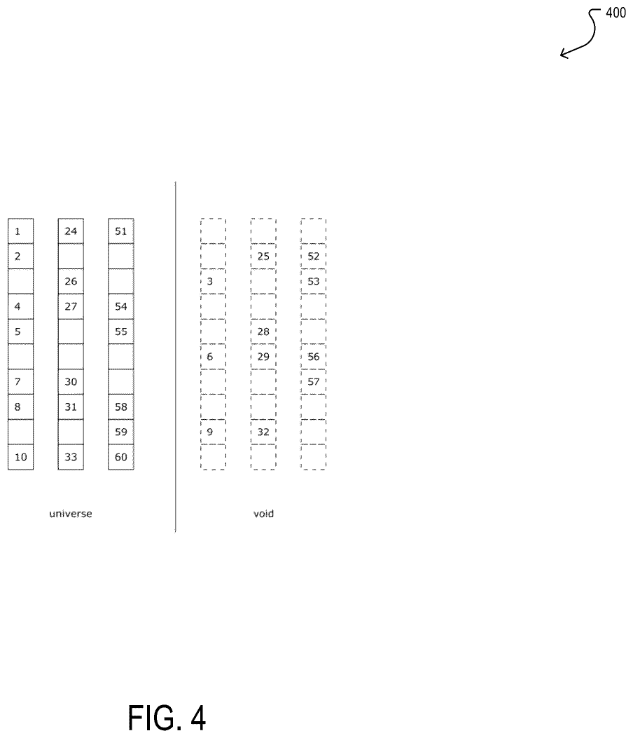

FIG. 4 shows frame banishing 400—the ability to send frames to the void according to an example of the instant disclosure. The void is a place where volumes and frames may still exist, however, they are not considered part of the universe while they are there. Special procedures are in place to make sure that they do not clash with the existence of volumes in the universe.

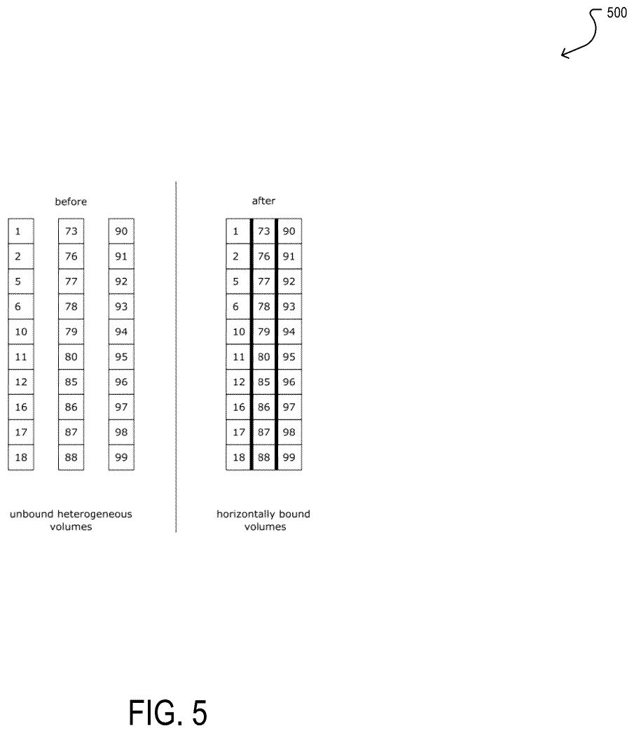

FIG. 5 shows horizontal volume binding 500—the ability to connect and bind heterogeneous types of volumes together according to an example of the instant disclosure. This gives the ability of volumes to share properties allowing for operations like matching, searching, and lateral indexing.

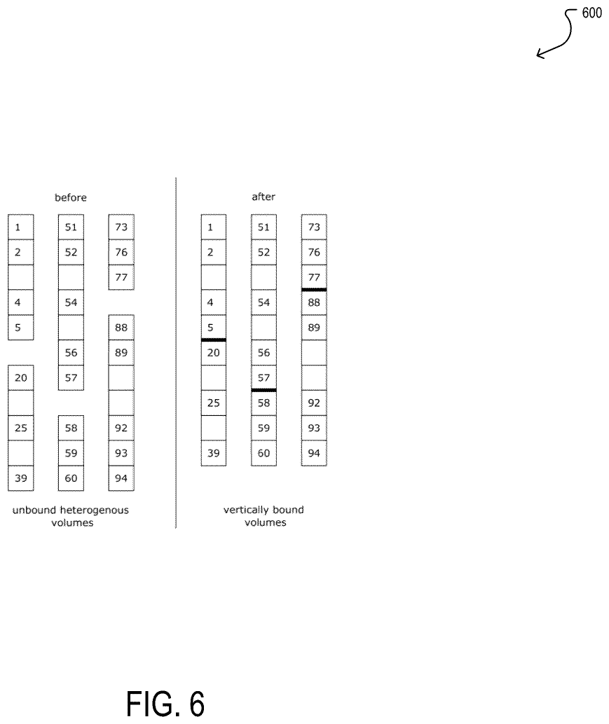

FIG. 6 shows vertical volume binding 600—the ability to bind volumes together by linking the heads and tails of different volumes according to an example of the instant disclosure. This gives the ability to extend existing properties and give more context to existing information.

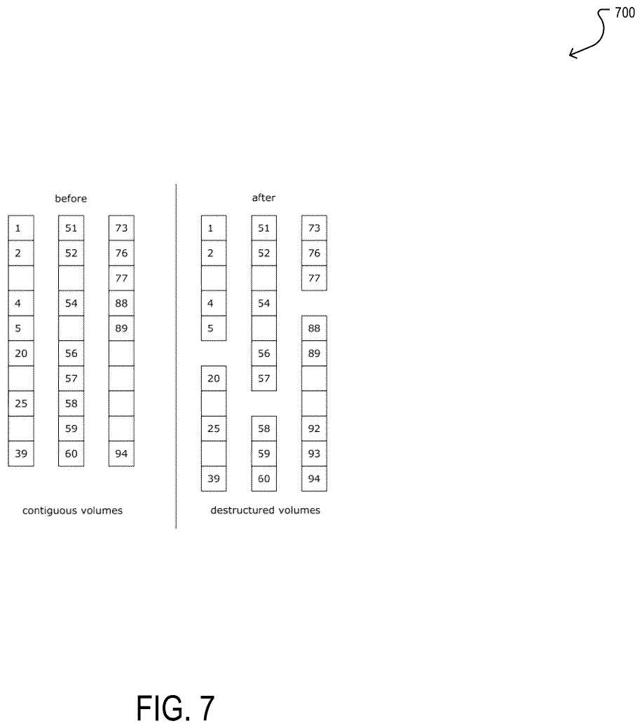

FIG. 7 shows volume destructuring 700—the ability to decomponentize volumes into arbitrary-sized frame groups and volume wrapping—the ability to create a globe of volumes, creating a monolithic volume group according to an example of the instant disclosure.

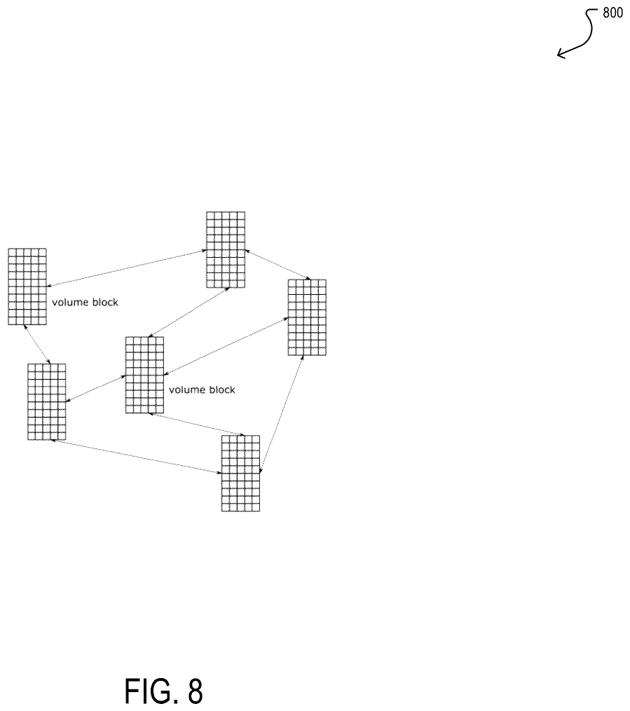

FIG. 8 shows interconnected volume blocks 800 according to an example of the instant disclosure. Because of the flexibility of volumes in taking arbitrary forms, it is possible to make computations not possible with traditional structures. Due to the property of a volume being both a container and binder, it is possible to manipulate data more dynamically and with finer grained control. Using the proper grouping of volumes, the system can create volume blocks configurations of volumes that contain specific traits and qualities. Using volume blocks, it is possible to create a network of interrelated volume groupings.

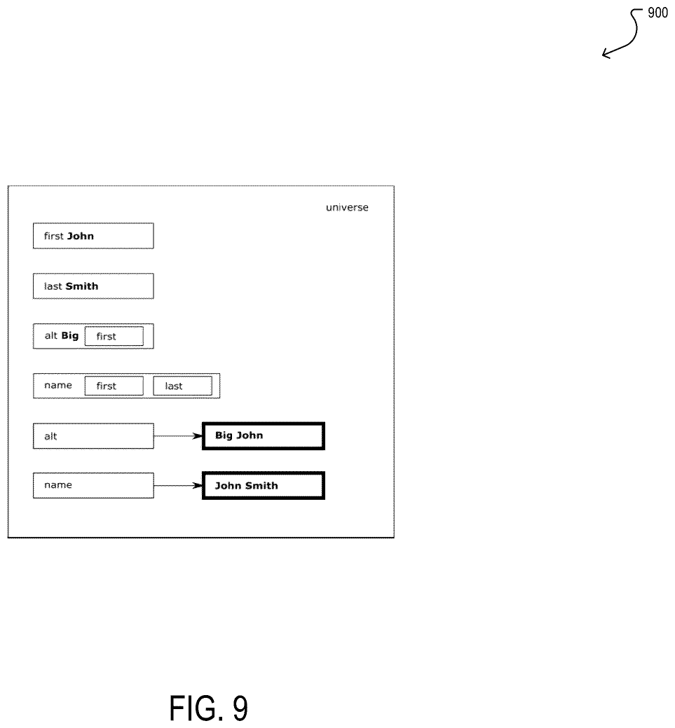

FIG. 9 shows basic and extended capsules 900 according to an example of the instant disclosure. Capsules are storage mechanisms that may allow one to manage nested encapsulated key-value information. With capsules, it is possible to create trees of relationships whilst preserving value context. When a parent or a child capsule changes property or value, the change becomes reflected in the whole subtree. The idea of capsules were inspired by earlier work on Mimix Stream Language (MSL).

Each capsule can contain arbitrary data, including the value of another capsule, allowing for nesting of capsules. Information that is contained in capsules is retrieved in the order that they were defined. In FIG. 9, the capsules 900 first and last are bound to John and Smith, respectively. The capsule alt is bound to Big and the value of the capsule first, which is John. Similarly, the capsule name is bound to the aggregate values of the capsules first and last.

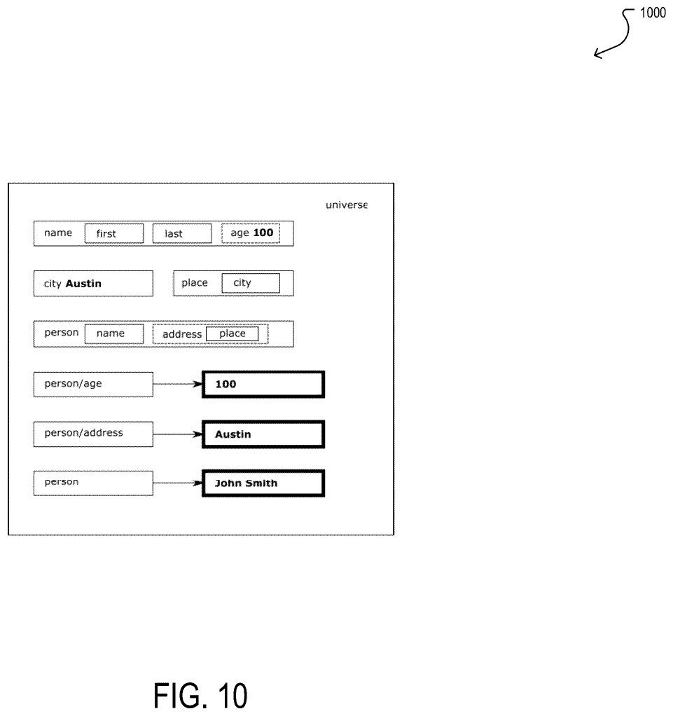

FIG. 10 shows sub-capsules 1000 according to an example of the instant disclosure. Sub-capsules on the other hand, are like capsules, but they can only live inside proper capsules. They allow data embedding, while providing a limited form of information hiding.

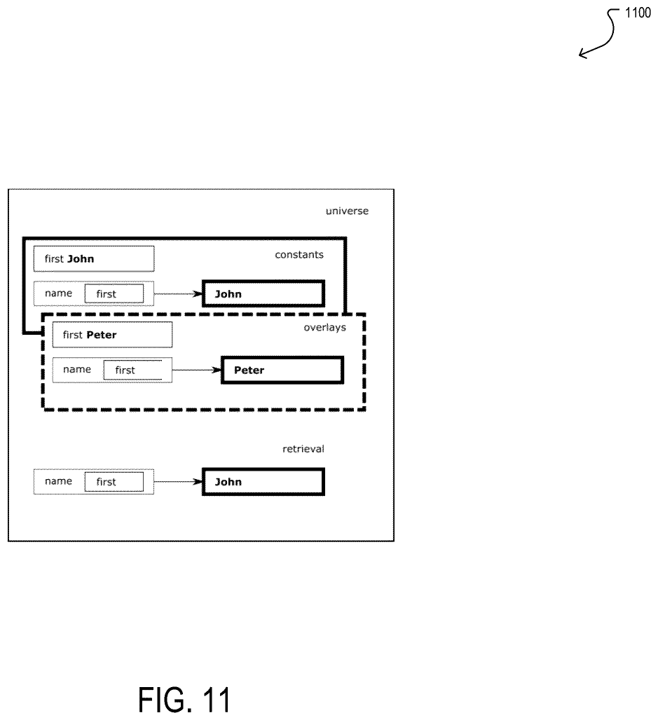

FIG. 11 shows constants and overlays 1100 according to an example of the instant disclosure. Constants allow bindings to a capsule that prevent new value bindings but allow for overlays on those constants to exist. Overlays provide a shadowing mechanism to constants within the environments where those constants exist. In FIG. 11, a constant is created on top-level binding the value John to the capsule first. Then, an overlay is made to temporarily bind a new value to the capsule first inside another environment. In that environment the value of the capsule first is Peter. However, outside of that overlay environment, the capsule name is still bound to the original value of John when the constant was first created.

A mini-language has been designed and is discussed herein to support the direct manipulation of the capsules-declarations. Declarations are user-level mechanisms to interact with the capsule system. It is a high-level language that has a similar syntax to s-expressions. A declaration can either retrieve a capsule value, set it to a new one, or overwrite the value of an existing one. At the most basic level, declarations are composed of terms, sub-terms, and constants. Terms, sub-terms, and constants correspond to capsules, sub-capsules, and constants in the object universe.

Terms are the basic building blocks of declarations. They can either be textual information or binary blobs. Sub-terms are terms that are inside terms. Constant terms, on other hand, are terms that do not change value inside a scope. When a new value is bound to a constant, inside another existing constant, the new, temporary value becomes the active one. When the new constant leaves the scope, the original value becomes visible again.

Example declarations are as follows:

Listing 1: Basic terms
1 (? first John)
2 (? last Smith)
3 (? alt Big (? first))
4 (? name (? first) (? last))
5 (? alt) => ″Big John″
6 (? name) => ″John Smith″
Listing 2: Basic sub-terms
1 (? first John)
2 (? last Smith)
3 (? name (? first) (? last) :age 100)
4 (? city Austin)
5 (? name :address (? city))
6 (? name :age) => ″100″
7 (? name :address) => ″Austin″
8 (? name) => ″John Smith″
Listing 3: Constant terms and overlays
1 ($ (? first John) (? name (? first))) => ″John″
2 (~ (? first Peter) (? name (? first))) => ″Peter″
3 (? name) => ″John″

Term names are not case-sensitive, so (? first John) are equivalent to (? FIRST John) and (? FiRsT John). Term values are implicitly quoted. Accumulation of information happens serially across time. All changes to a declaration are captured. This feature enables arbitrary rollbacks.

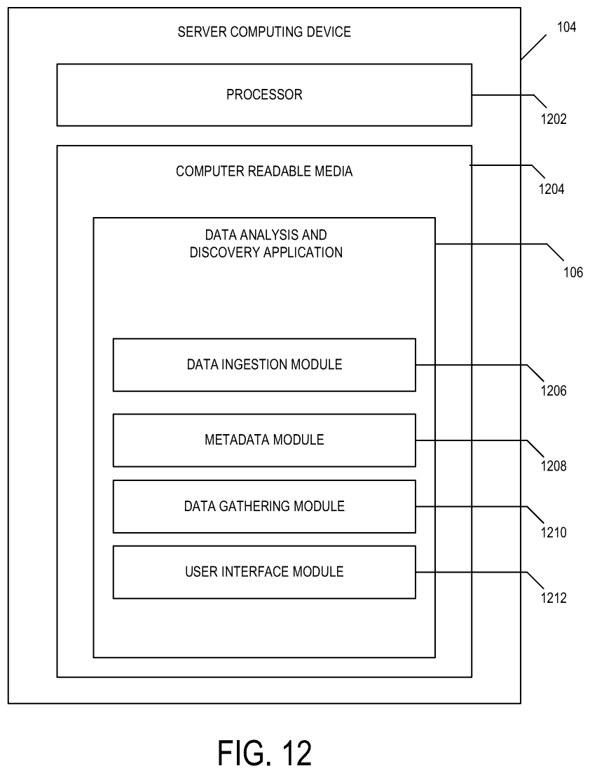

FIG. 12 is a block diagram of the data analysis and discovery application 106, also known as Valmiz, according to an example of the instant disclosure. The data analysis and discovery application 106 may be executed by the server computing device 104. The server computing device 104 includes computer readable media (CRM) 1204 in memory on which the data analysis and discovery application 106 is stored. The computer readable media 1204 may include volatile media, nonvolatile media, removable media, non-removable media, and/or another available medium that can be accessed by the processor 1202. By way of example and not limitation, the computer readable media 1204 comprises computer storage media and communication media. Computer storage media includes non-transitory storage memory, volatile media, nonvolatile media, removable media, and/or non-removable media implemented in a method or technology for storage of information, such as computer/machine-readable/executable instructions, data structures, program modules, or other data. Communication media may embody computer/machine-readable/executable instructions, data structures, program modules, or other data and include an information delivery media or system, both of which are hardware.

As an example, the data analysis and discovery application 106 may include a number of modules as described below. The modules may be Common Lisp (CL) modules, or may be other types of modules.

The data analysis and discovery application 106 may include a data ingestion module 1206 according to an example of the instant disclosure. As an example, the data ingestion module 1206 may fuse knowledge graphs and knowledge bases using artificial intelligence. The data ingestion module 1206 may convert raw data into indexable knowledge stores. The input data can be comma-separated values (CSV), spreadsheet (XLSX, ODS), and JSON files and streams, among others. The output information is a compound data structure containing the results of a query.

When the data ingestion module 1206 ingests data sources, the data ingestion module 1206 can create a semantic network of all the available data points from the sources. When handling tabular data like CSV files, the data ingestion module 1206 creates a knowledge graph network wherein all nodes are essentially connected to one another making lookups and traversals across disparate data sources possible. The data ingestion module 1206 can create a universe of registries and volumes to which data is stored. When a cluster of flat databases like CSV files are fed into the data ingestion module 1206, it can create a three dimensional representation of the input connecting every unit of information to each other across the different files. With the data files, the data ingestion module 1206 enables the creation and extraction of contextual information cluster based on the input that was given.

The data analysis and discovery application 106 may include a metadata module 1208 according to an example of the instant disclosure. The metadata module 1208 may track key-value-metadata changes.

The input data may be terms. These are textual representations of information that closely resemble s-expressions. The output information is a pair of 1) a new term that results from the evaluation of the input term, and 2) the value as a result of the evaluation. Terms may include a name, an optional value, and optional metadata. Terms within terms are possible through nesting. Value preservation is possible with the use of constants. With the metadata module 1208, it is possible to capture data then add more data to it linearly across time. When compounded as a single object, a capsule—the object representation of a term—contains an identifier, a primary value, and an arbitrary amount of metadata key-value pairs. All changes that happen with terms are tracked linearly across time. This enables rollbacks to an arbitrary point in time.

The data analysis and discovery application 106 may include a data gathering module 1210 according to an example of the instant disclosure. The data gathering module 1210 may gather and obtain data from different data sources, including, but not limited to text, video, and audio, found on the internet, local networks, and disks. When used over networks like the internet, it works by collecting information across publicly available sources like wikis, spreadsheets, corpora, and other public domain resources. When used over intranets, the data gathering module 1210 may work by ingesting pre-existing data sets from private sources like company documents and open directories. The data gathering module 1210 may operate as a passive service and collect data within the constraints that were specified prior to running it.

The data analysis and discovery application 106 may include a user interface module 1212 according to an example of the instant disclosure. The user interface module 1212 may receive requests or other communications from the client computing device 102 and transmits a representation of requested information, user interface elements, and other data and communications to the client computing device 102 for display on the display. As an example, the user interface module 1212 generates a native and/or web-based graphical user interface (GUI) that accepts input and provides output by generating content that is transmitted via the communications network 108 and viewed by a user of the client computing device 102. The user interface module 1212 may provide realtime automatically and dynamically refreshed information to the user of the client computing device 102 using Java, JavaScript, AJAX (Asynchronous JavaScript and XML), ASP.NET, Microsoft NET, and/or Node.js, among others. The user interface module 1212 may send data to other modules of the data analysis and discovery application 106 of the server computing device 104, and retrieve data from other modules of the data analysis and discovery application 106 of the server computing device 104 asynchronously without interfering with the display and behavior of the client computing device.

As another example, the user interface module 1212 may be a human-machine interface for receiving commands in the form of text keywords and voice data, and dispatching commands based on the input. With the textual interface, the user interface module 1212 may listen for commands as text, buffers the commands, then sends the commands to the appropriate module of the system 100. As a voice interface, the user interface module 1212 can listen for voice commands, converts the voice commands into text, and dispatches commands.

When used with the textual interface, the user interface module 1212 may listen on a network port for commands, processes the commands, and then sends back the results of the query in the form of text blobs. This can be a default interface when used by developers and backend engineers, since the textual interface can return the raw information which contains other data like metadata.

When used with the voice interface, the voice command is first converted to text. However, instead of returning text globs, the results can be presented in a graphical user interface (GUI).

The GUI can be associated with the data analysis and discovery application 106. As an example, the GUI could be web based and/or mobile and continually listens for commands in the form of keywords. Each successive keyword refines the result that will be shown on the screen, as a compound live image that can be interacted with via keyboard, mouse, or touch. Predefined control keywords—“stop” and “resume”—are set up so that results will be delivered fluidly and in real time. This removes the necessity to use an explicit “Ok” or “Submit” button. When instantiated as a mobile app, the user interface module 1212 could passively listen to voice commands. An example interaction would be: “X, pasta, Jane Doe, red motorcycle, last week, stop”. In that sequence, the user interface module 1212 is first called to attention with the keyword “X,” then the remaining words are keyword commands.

When a user says “pasta” the screen can show the most recent information about pasta relative to you, then when the user says “Jane Doe,” the screen can be updated with items that pertain to both “pasta” and “Jane Doe.” When a user reaches “stop” the screen can pause the updates, and freezes the information presented on the screen, then the user can select from the results the information that the user may most likely want to extract. If for example, the user has already found what the user was looking for after the user said “red motorcycle,” the user can tap the results from the screen and obtain the information as desired.

As an example, the data analysis and discovery application 106 may be used for a variety of different use cases and purposes. In particular, the data analysis and discovery application 106 may be used as a general election system, an election security system, a healthcare services system, a pharmaceutical technology quality assurance system, a cybersecurity Audit Readiness system, an aerospace system, an autonomous vehicle system, and a wireless energy system, among others.

When used via a Web application programming interface (API), the client computing device 102 connects to and makes requests to the server computing device 104 and receives results. The client computing device 102 could be an automated client or one that is operated by a human user. The API can connect to the data analysis and discovery application and each module may perform a specific task for that direction.

When communicating with the server computing device 104, a user can send queries and get back information blocks as a result. The basic form of a query can be a sequence of words, whether inputted via plain text or voice. The result is a conglomerate of data in the form of JSON to maximize systems compatibility. When communicating with the server computing device 104, a user can send terms for evaluation. The result are terms that reflect the result of the evaluation process. Communicating with server computing device 104 also triggers indirect communication with one or more modules because terms receive further processing.

When communicating with the server computing device 104, a user can interact directly with the core AI system in a fine grained manner. This allows direct execution of commands like volume and registry management, searching for specific data stores, and other operations like data filtration and file ingestion. When communicating with the server computing device 104, a user is allowed to control the parameters that the server computing device 104 is using for collecting data across the internet, intranets, local drives, and other data sources. A user is given the ability to extract raw information from the data that the server computing device 104 has collected, yielding information like origin of data, timestamps, and link dumps. Another way of communicating with server computing device 104 is through a local API. As an example, the client computing device 102 may have a native application that communicates directly with the server computing device 104 to extract information. When queried, the server computing device 104 can provide direct data dumps that it has processed. Similarly, the server computing device 104 may provide raw dumps of the data that it has collected.

In order to load data from cold storage, the server computing device 104 can convert the information in RAM to a form that can be stored on hard drives. As an example, the information may be stored as a textual representation, including S-Exps, XML, JSON, YAML. In addition, the information may be stored as a binary representation such as a binary file, a full Lisp heap dump, or a memory-mapped file. In addition, the information may be stored in the database 110.

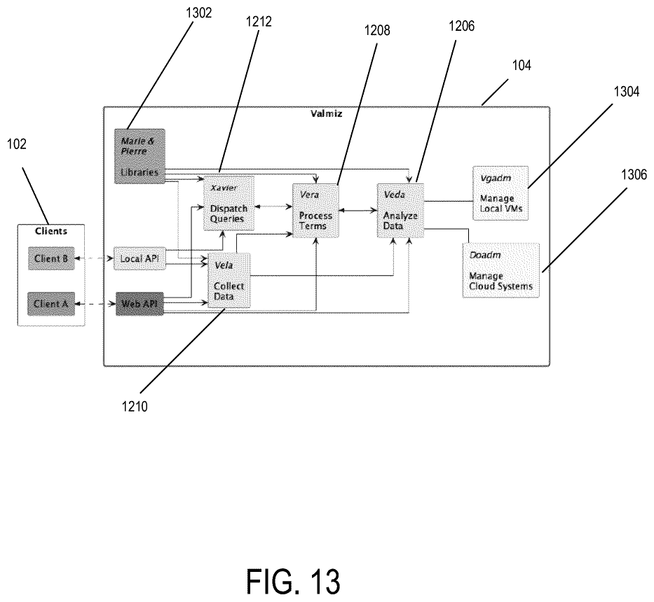

FIG. 13 shows another block diagram of the system 100 according to an example of the instant disclosure. The system may include the server computing device 104 that may include the modules that together function as a collection of intelligent agents for information augmentation to provide data analysis and discovery. As shown in FIG. 13, there may be one or more client computing devices 102 such as client A and client B. The server computing device 104 may include the data ingestion module 1206, also known as Veda, that may analyze data. In addition, the server computing device 104 may include the metadata module 1208, also known as Vera, to process terms. The server computing device 104 may include the data gathering module 1210, also known as Vela, to analyze data. The server computing device 104 may include the user interface module 1212, also known as Xavier, to receive queries and return results to the client computing devices 102.

As further shown in FIG. 13, Doadm 1306 is both the command line program and library for administering resources on DigitalOcean servers. Doadm 1306 can support the creation, updating, deletion, and status retrieval of droplets. The same set of operations are also available for databases, firewalls, and domain names. Remote servers—droplets—are used for the deployment of machines to serve instances of the server computing device 104 and/or modules associated with the application 106.

Vgadm 1304 may be a command line program for administering virtual machines (VMs). Vgadm 1304 can use Vagrant and VirtualBox to manage local VMs. Just like Doadm 1306, Vgadm 1304 can support the creation, updating, deletion, and status retrieval of VMs. Locally-managed virtual machines are used for managing private instances of the server computing device 104, especially where privacy and confidentiality of information is paramount. Vgadm 1304 can be primarily used for sites that are not connected to the internet.

In order to facilitate the delivery of common code across the server computing device 104, dedicated libraries 1302 that provide subroutines have to be used. Marie can be a collection of functions that have no external dependencies, i.e., all the functionality contained inside Marie do not depend on libraries written by other people. Pierre, on the other hand, is a collection of functions, just like Marie, but it depends on 3rd-party software.

The separation of code between these components are designed so that it is clear which component or module relies on the work of others, in order to evaluate the possibility of implementing those functionality ourselves.

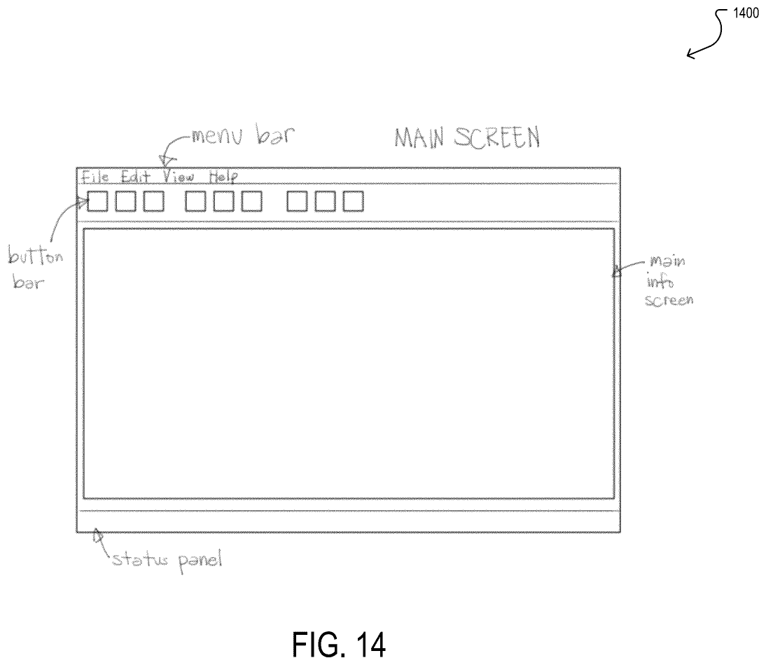

FIG. 14 is an example of a graphical user interface (GUI) 1400 of the data analysis and discovery system 100 according to an example of the instant disclosure. As an example, as shown in FIG. 14, the GUI 1400 may include a button bar having one or more buttons, a status panel, and a main information area, among other graphical user interface elements.

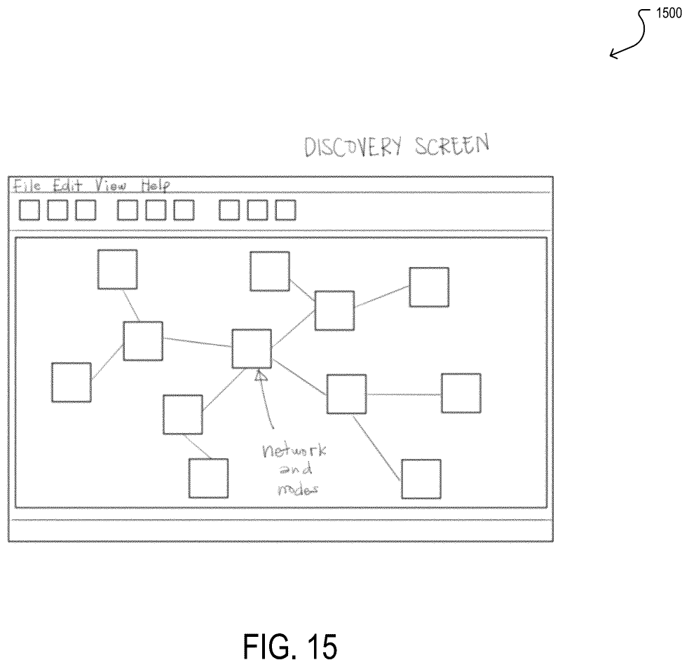

FIG. 15 is another example of a GUI 1500 of the data analysis and discovery system 100 according to an example of the instant disclosure. As shown in FIG. 15, the GUI 1500 may show a network and nodes that are connected with one or more other nodes.

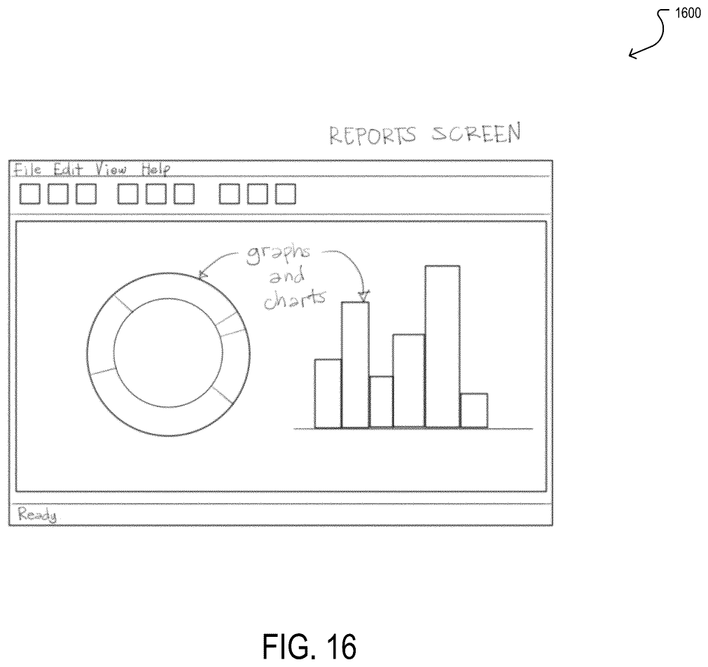

FIG. 16 is another example of a GUI 1600 of the data analysis and discovery system 100 according to an example of the instant disclosure. As shown in FIG. 16, there may be graphics and charts associated with the data as displayed in the GUI 1600.

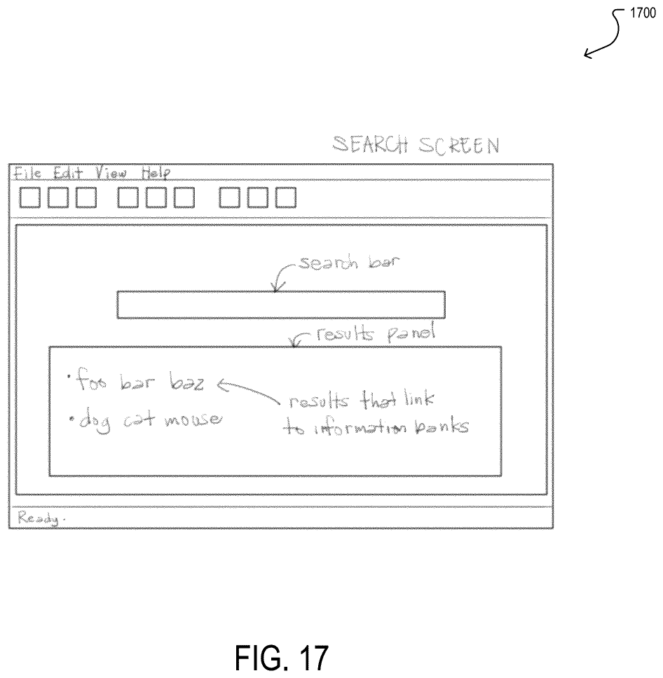

FIG. 17 is another example of a GUI 1700 of the data analysis and discovery system 100 according to an example of the instant disclosure. As shown in FIG. 17, the GUI 1700 may have a search bar graphical user interface element and a results panel graphical user interface element. The results may be linked to information banks.

The data ingestion module or Veda 1206 is the core AI system that fuses knowledge graphs and knowledge bases. It is the component of the system 100 that is responsible for converting raw data into indexable knowledge stores. The input data can be comma-separated values (CSV), spreadsheet (XLSX, ODS), and JSON files and streams. The output information is a compound data structure containing the results of a query.

When the data ingestion module or Veda 1206 ingests data sources, the data ingestion module 1206 can create a semantic network of all the available data points from the sources. When handling tabular data like CSV files, Veda creates a knowledge graph network wherein all nodes are essentially connected to one another making lookups and traversals across disparate data sources possible.

The data ingestion module or Veda 1206 creates a universe of registries and volumes to which data is stored. When a cluster of flat databases like CSV files are fed into the data ingestion module or Veda 1206, the data ingestion module 1206 creates three-dimensional representation of the input connecting every unit of information to each other across the different files. With the data, the data ingestion module 1206 enables the creation and extraction of contextual information cluster based on the input that was given.

The true power of the data ingestion module 1206 may be associated with creating worlds within worlds.

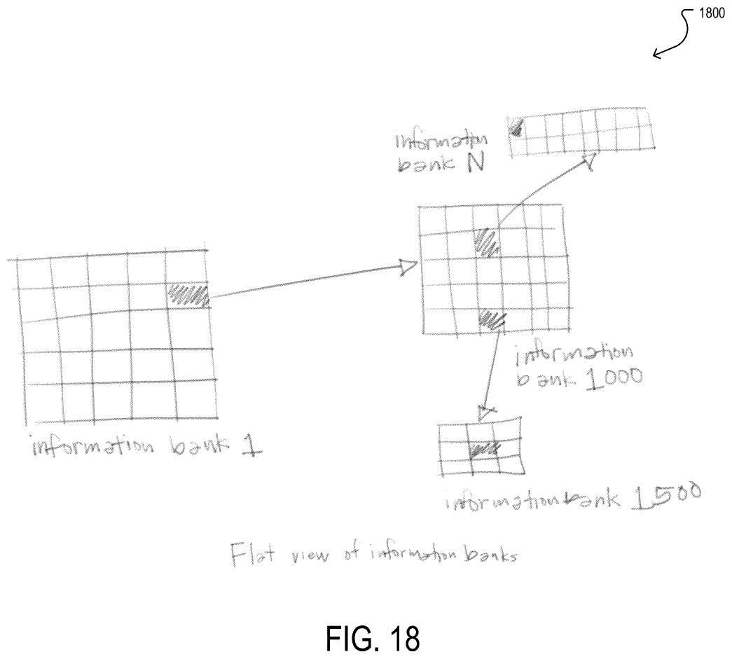

FIG. 18 shows a first example 1800 of a visualization of how Veda 1206 stores information according to an example of the instant disclosure.

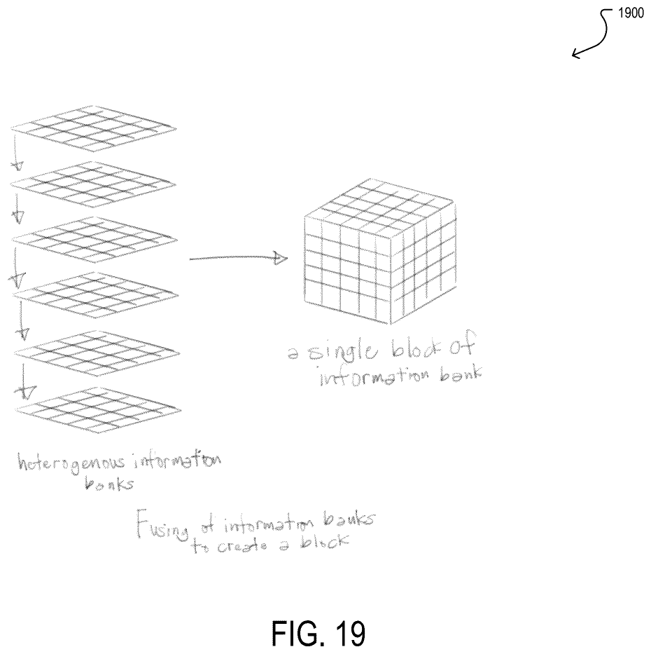

FIG. 19 shows a second example 1900 of a visualization of how Veda 1206 stores information according to an example of the instant disclosure.

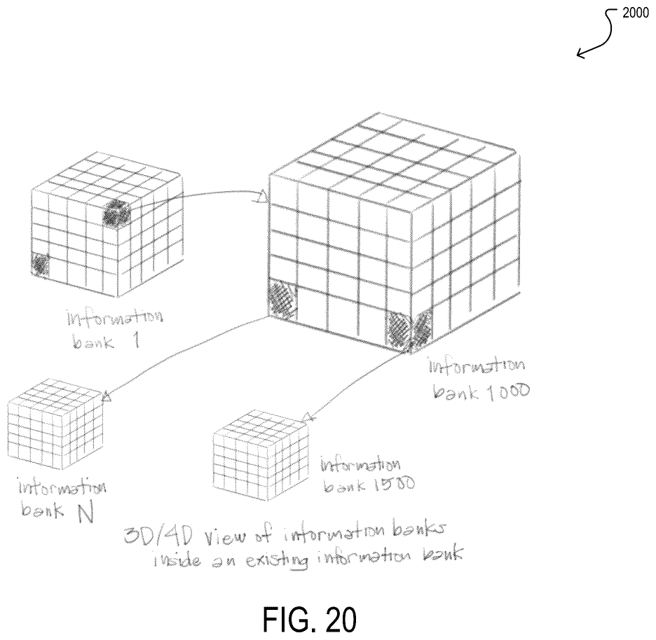

FIG. 20 shows a third example 2000 of a visualization of how Veda 1206 stores information according to an example of the instant disclosure.

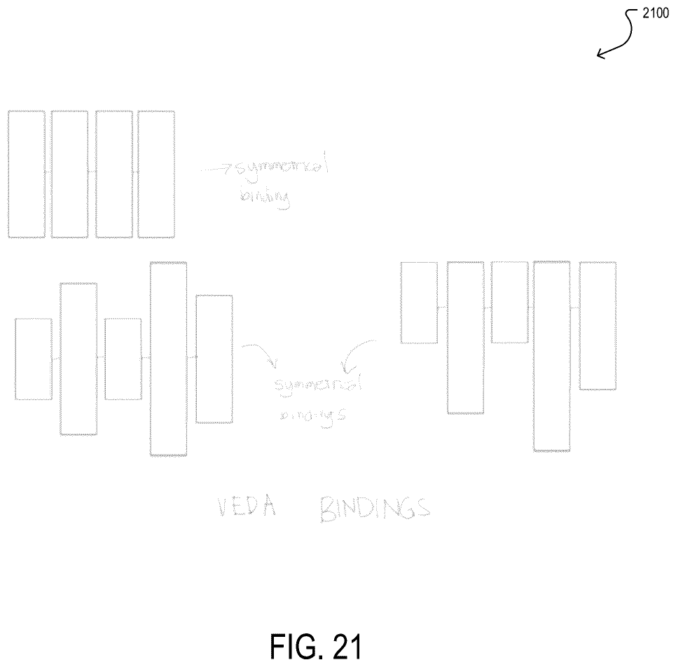

FIG. 21 shows a fourth example 2100 of a visualization of how Veda 1206 stores information using bindings according to an example of the instant disclosure.

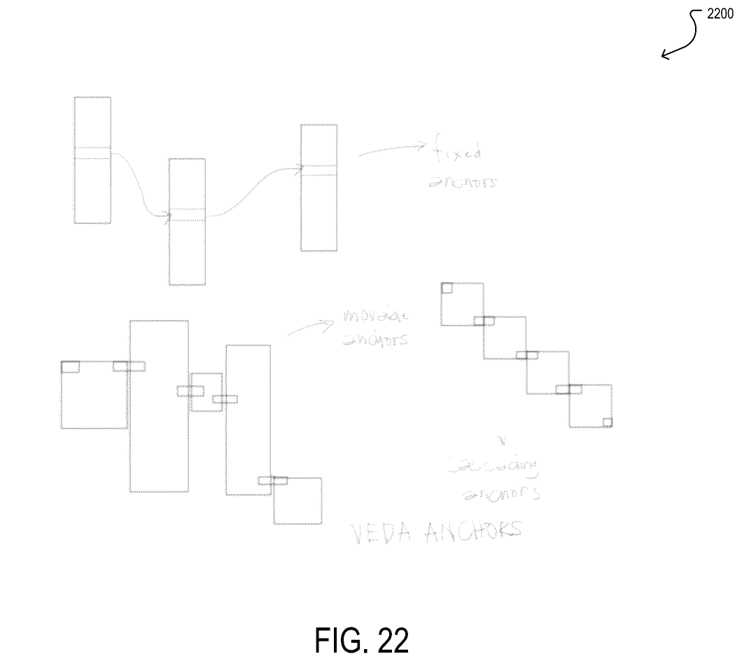

FIG. 22 shows a fifth example 2200 of a visualization of how Veda 1206 stores information using anchors according to an example of the instant disclosure.

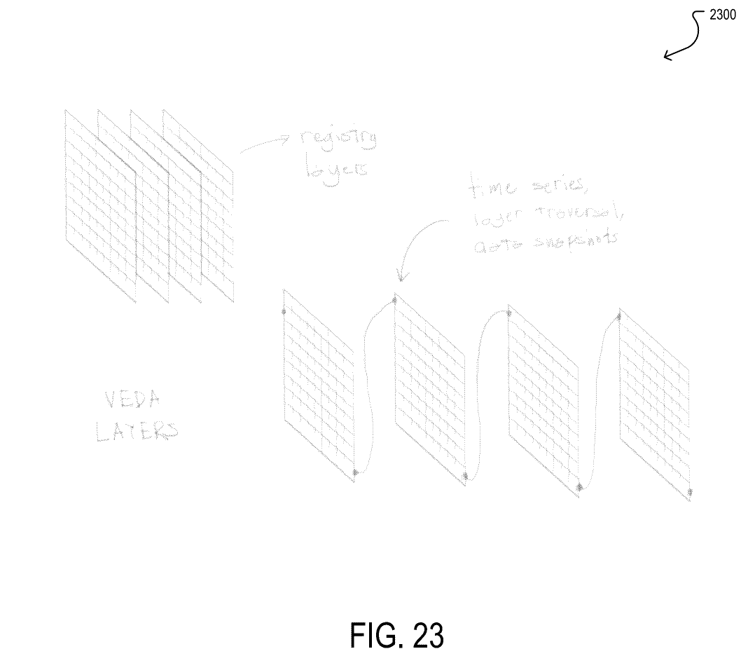

FIG. 23 shows a sixth example 2300 of a visualization of how Veda 1206 stores information using layers according to an example of the instant disclosure.

The component of the data analysis and discovery application 106 that tracks key-value-metadata changes is Vera 1208. The input data are called declarations. These are textual representations of information that closely resemble s-expressions. The resulting information is a pair of 1) a new declaration that results from the evaluation of the input declaration, and 2) the value as a result of the evaluation.

Declarations are composed of a name, an optional value, and an optional metadata. Declarations within declarations are possible through nesting. Value preservation is possible with the use of constants.

With Vera 1208, it is possible to capture data then add more data to it linearly across time. When compounded as a single object, a capsule—the object representation of a declaration contains an identifier, a primary value, and an arbitrary amount of metadata key-value pairs. All changes that happen with declarations are tracked linearly across time. This enables rollbacks to an arbitrary point in time.

An example EBNF Definition is provided below:

```
/*------------------------------------------------------------------------------
  top-level */
document ::= declaration+
declaration ::= normal-term
      | constant-term
      | overlay-term
/*------------------------------------------------------------------------------
  term */
normal-term ::= ″(″ ″?″ atom ″)″
constant-term ::= ″(″ ″$″ normal-term+ ″)″
overlay-term ::= ″(″ ″~″ normal-term+ ″)″
/*------------------------------------------------------------------------------
  atom */
atom ::= atom-name
    | atom-name atom-value+
    | atom-name metadata
    | atom-name atom-value metadata
    | declaration
atom-name ::= letter*
      | letter* number*
atom-value ::= letter* | number*
/*------------------------------------------------------------------------------
  metadata */
metadata ::= metadata-name
      | ( metadata-name metadata-value )+
metadata-name ::= ″:″ ( letter* | letter* number* )
metadata-value ::= letter* | number*
/*------------------------------------------------------------------------------
  alphanumeric */
letter ::= [a-zA-Z]+
number ::= [0-9]+
/*------------------------------------------------------------------------------
  regex */
regex ::= match
    | ( match replacement )
match ::= ″/″ re ″/″
replacement ::= ″/″ re ″/″
re ::= union | simple-re
union ::= re ″|″ simple-re
simple-re ::= concatenation | basic-re
concatenation ::= simple-re basic-re
basic-re ::= star | plus | elementary-re
star ::= elementary-re ″*″
plus ::= elementary-re ″+″
elementary-re ::= group | any | eos | char | set
group ::= ″(″ RE ″)″
any ::= ″.″
eos ::= ″$″
char ::= any non metacharacter | ″\″ metacharacter
set ::= positive-set | negative-set
positive-set ::= ″[″ set-items ″]″
negative-set ::= ″[\hat{ }″ set-items ″]″
set-items ::= set-item | set-item set-items
set-items ::= range | char
range ::= char ″-″ char
```

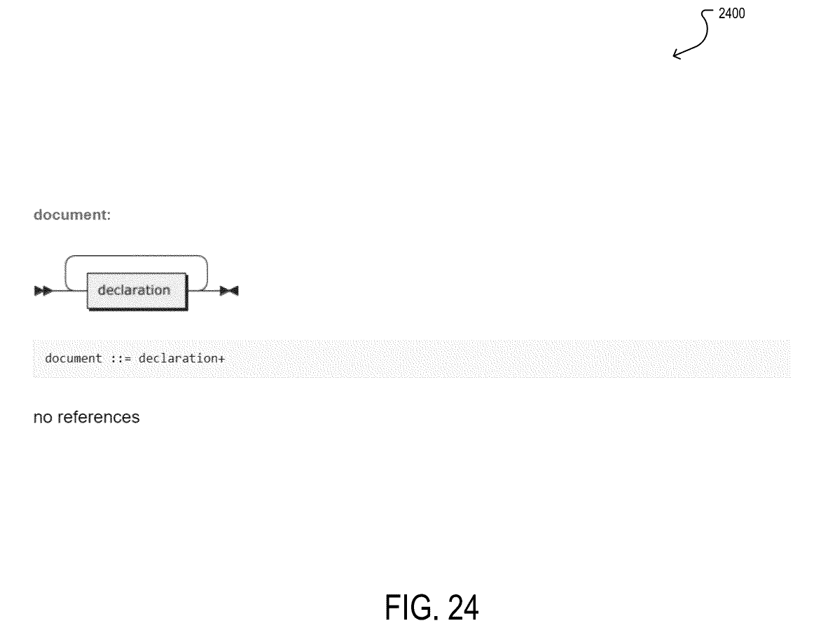

FIGS. 24-54 illustrate diagrams associated with extended Backus-Naur form (EBNF) providing a formal description of a formal language associated with the data analysis and discovery system according to an example of the instant disclosure.

FIG. 24 shows an example EBNF diagram 2400 associated with document according to an example of the instant disclosure.

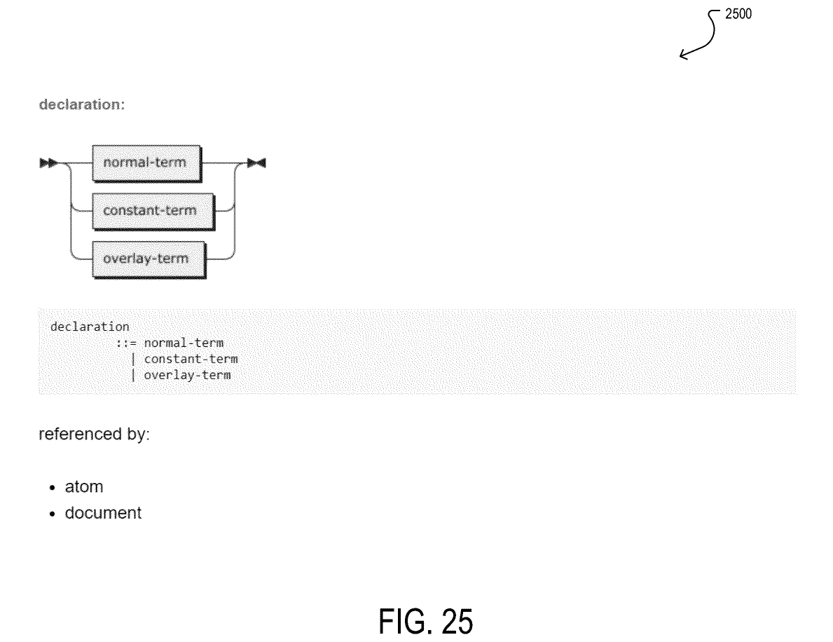

FIG. 25 shows an example EBNF diagram 2500 associated with declaration according to an example of the instant disclosure.

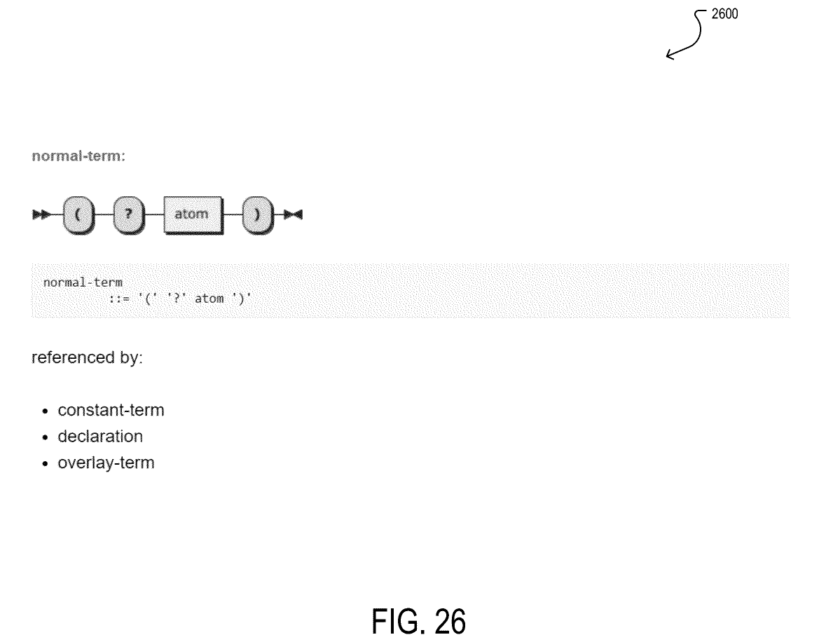

FIG. 26 shows an example EBNF diagram 2600 associated with normal-term according to an example of the instant disclosure.

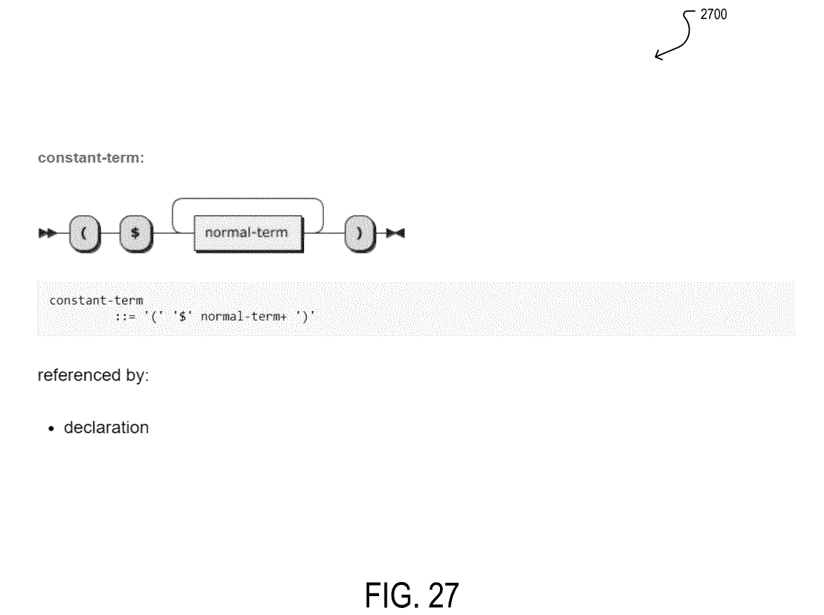

FIG. 27 shows an example EBNF diagram 2700 associated with constant-term according to an example of the instant disclosure.

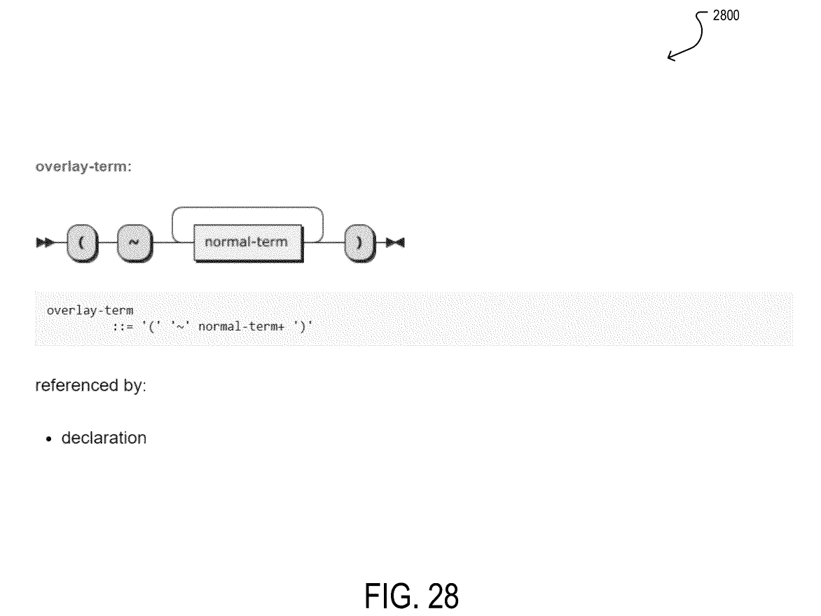

FIG. 28 shows an example EBNF diagram 2800 associated with overlay-term according to an example of the instant disclosure.

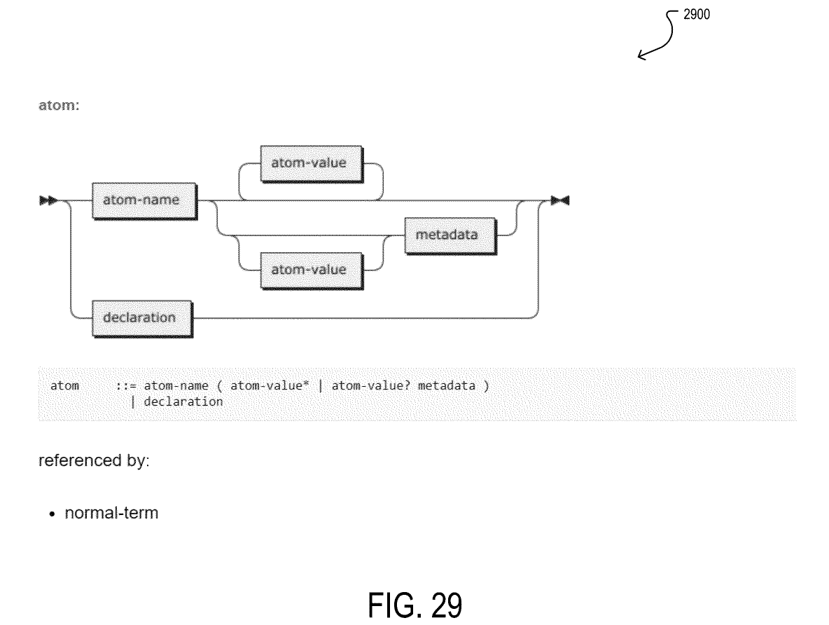

FIG. 29 shows an example EBNF diagram 2500 associated with atom according to an example of the instant disclosure.

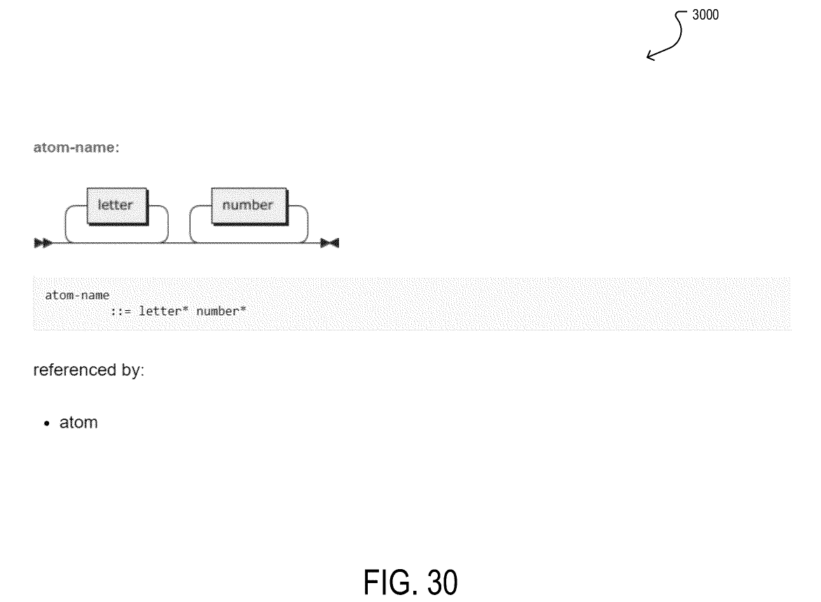

FIG. 30 shows an example EBNF diagram 3000 associated with atom-name according to an example of the instant disclosure.

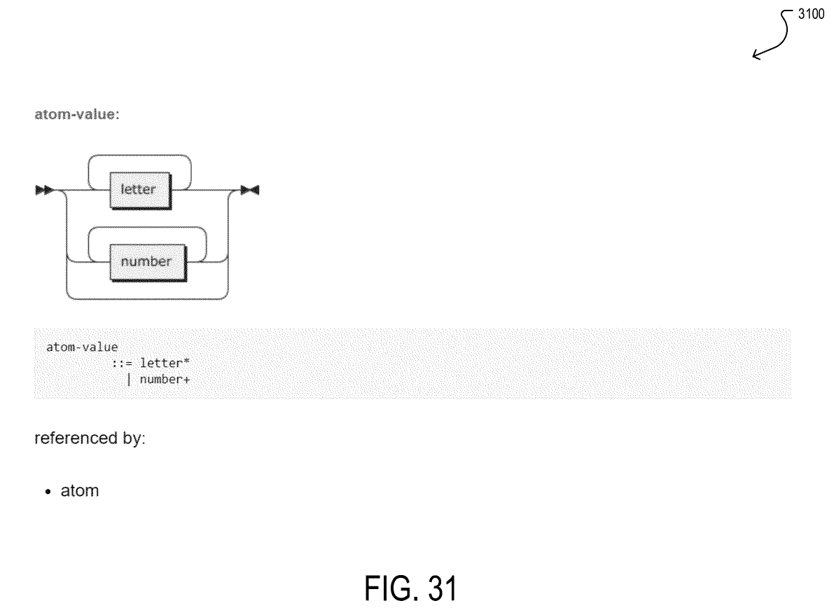

FIG. 31 shows an example EBNF diagram 3100 associated with atom-value according to an example of the instant disclosure.

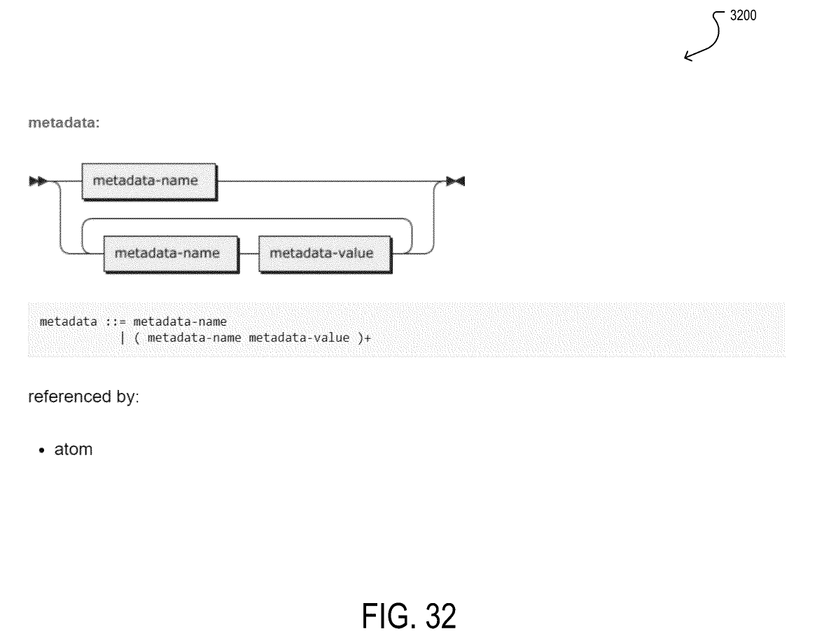

FIG. 32 shows an example EBNF diagram 3200 associated with metadata according to an example of the instant disclosure.

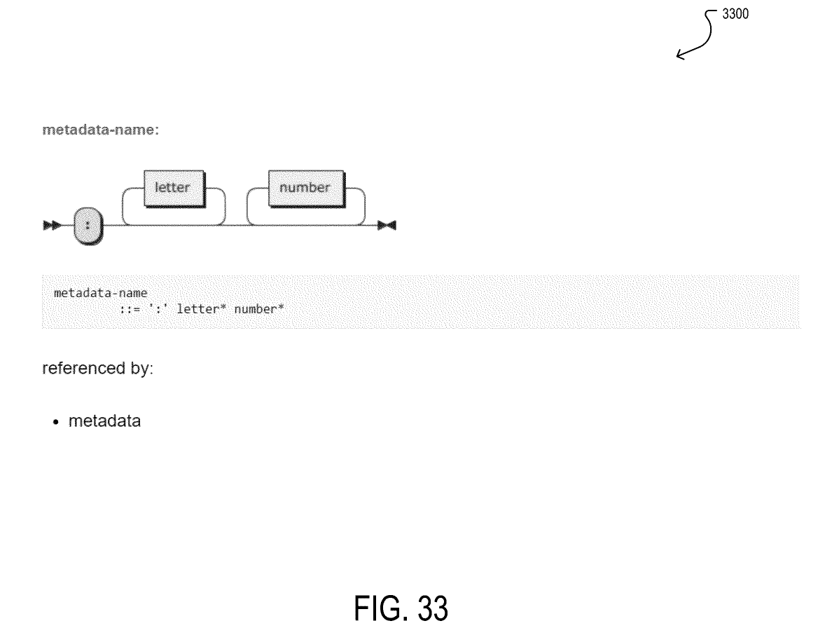

FIG. 33 shows an example EBNF diagram 3300 associated with metadata-name according to an example of the instant disclosure.

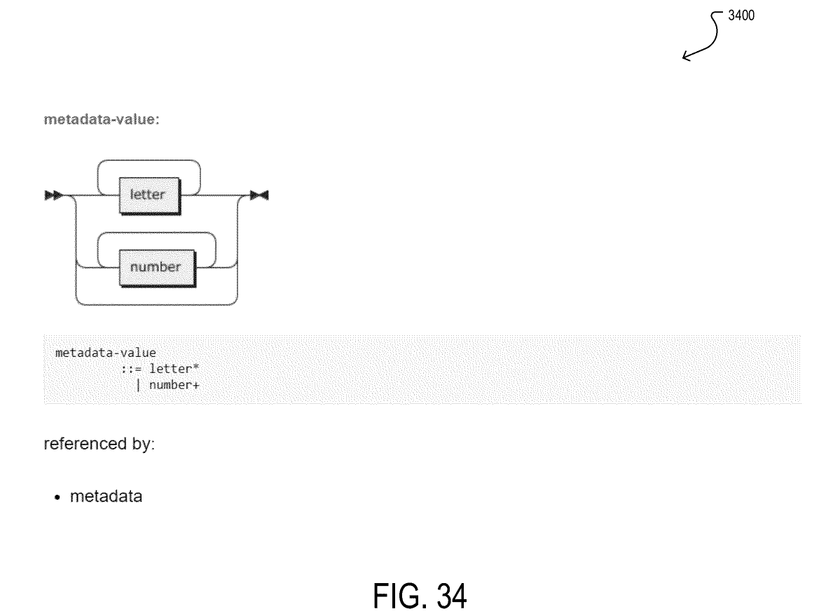

FIG. 34 shows an example EBNF diagram 3400 associated with metadata-value according to an example of the instant disclosure.

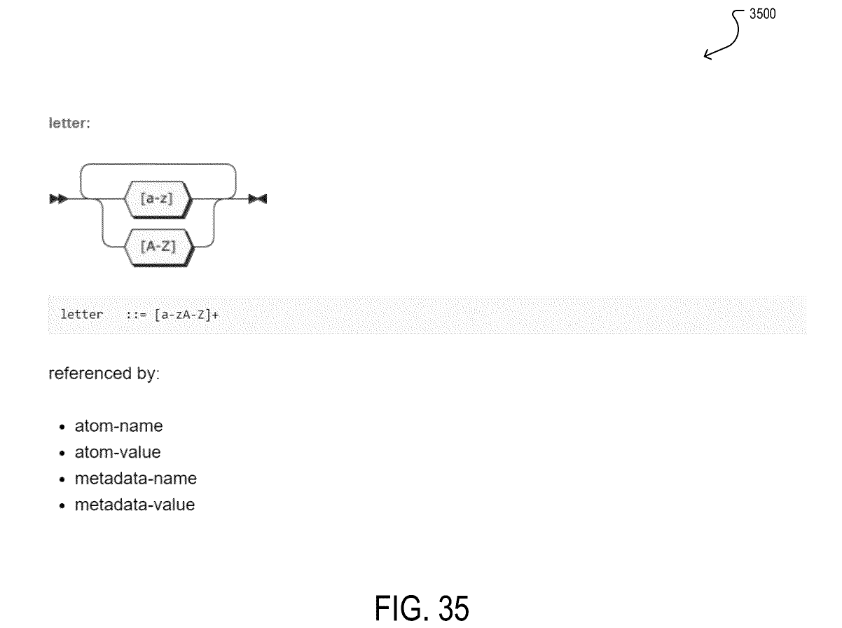

FIG. 35 shows an example EBNF diagram 3500 associated with letter according to an example of the instant disclosure.

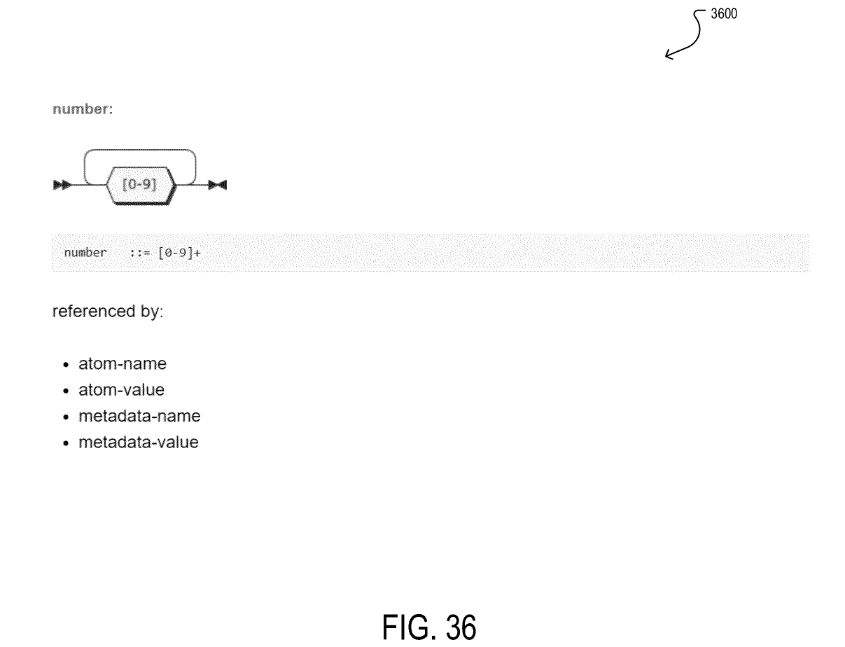

FIG. 36 shows an example EBNF diagram 3600 associated with number according to an example of the instant disclosure.

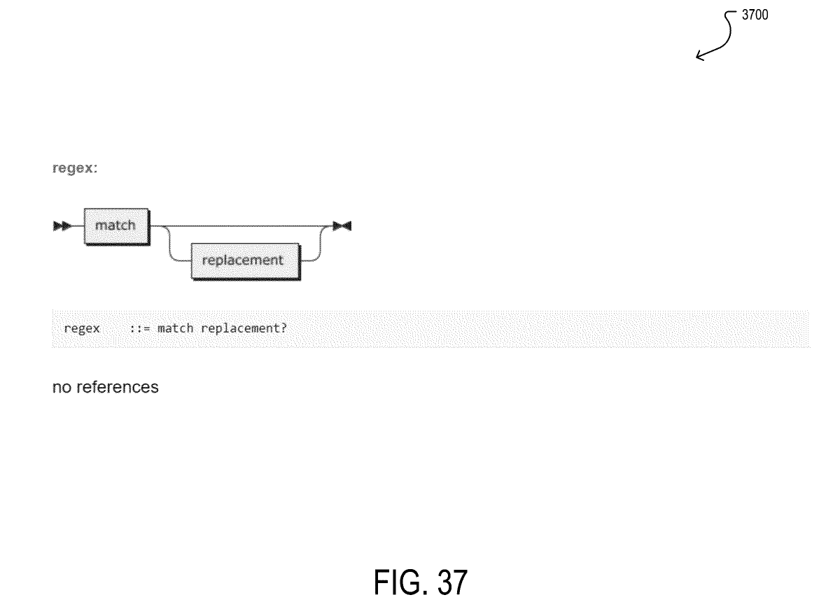

FIG. 37 shows an example EBNF diagram 3700 associated with regex according to an example of the instant disclosure.

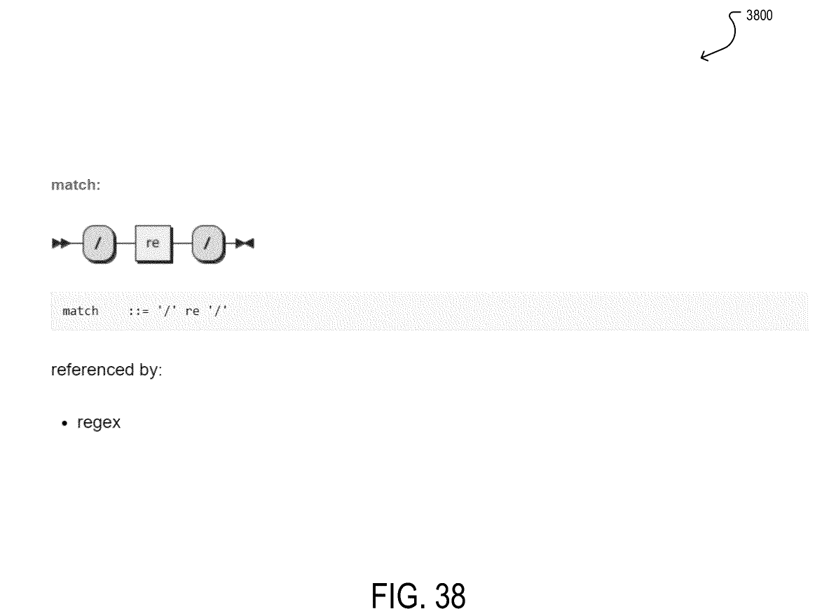

FIG. 38 shows an example EBNF diagram 3800 associated with match according to an example of the instant disclosure.

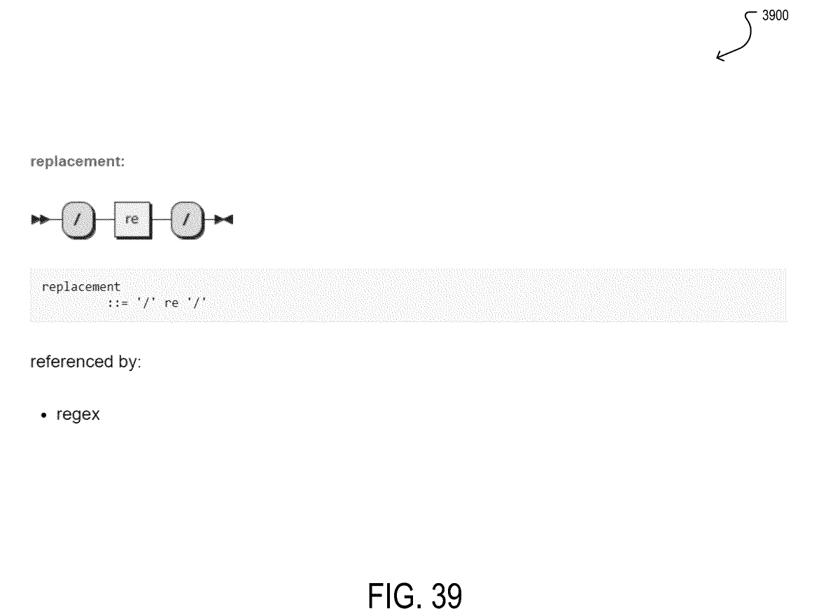

FIG. 39 shows an example EBNF diagram 3900 associated with replacement according to an example of the instant disclosure.

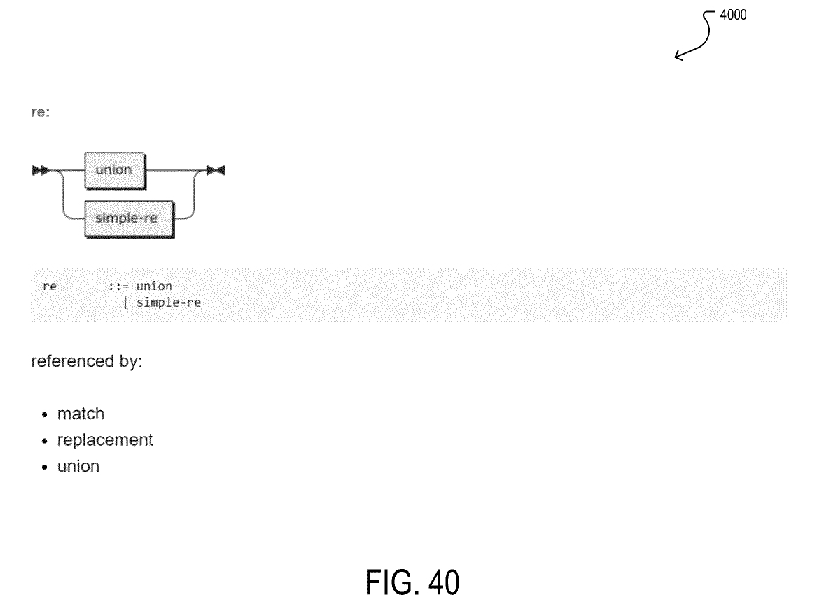

FIG. 40 shows an example EBNF diagram 4000 associated with re according to an example of the instant disclosure.

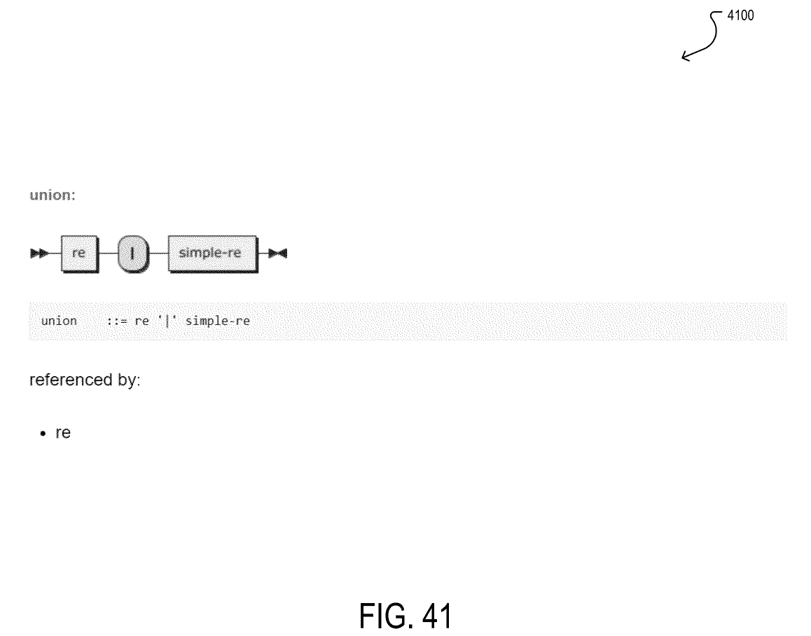

FIG. 41 shows an example EBNF diagram 4100 associated with union according to an example of the instant disclosure.

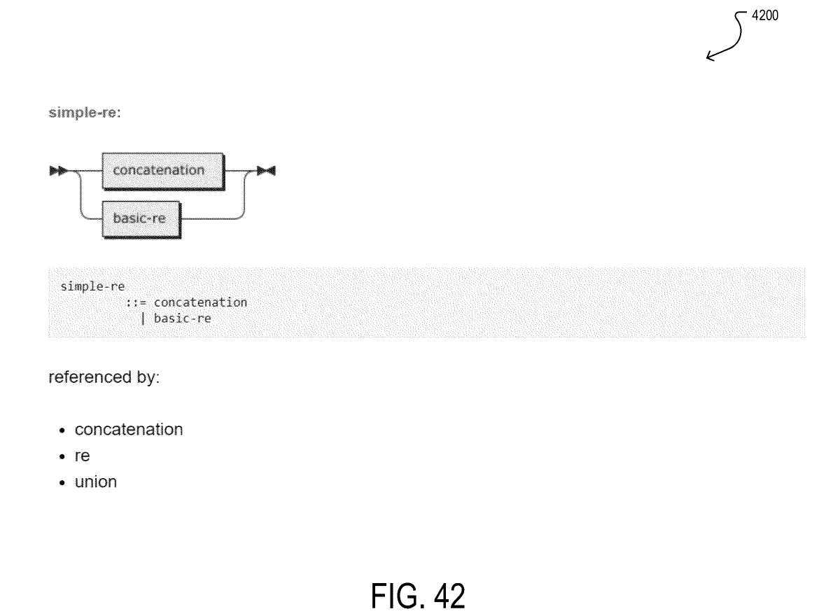

FIG. 42 shows an example EBNF diagram 4200 associated with simple-re according to an example of the instant disclosure.

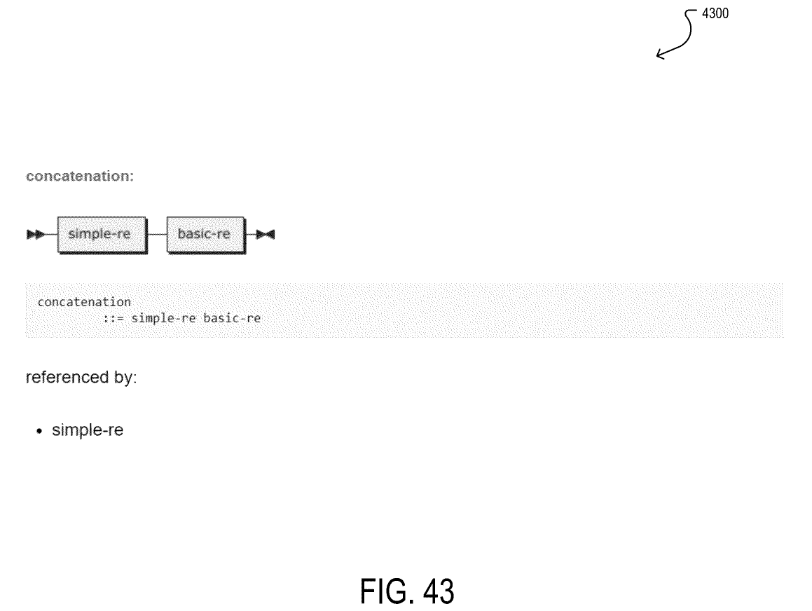

FIG. 43 shows an example EBNF diagram 4300 associated with concatenation according to an example of the instant disclosure.

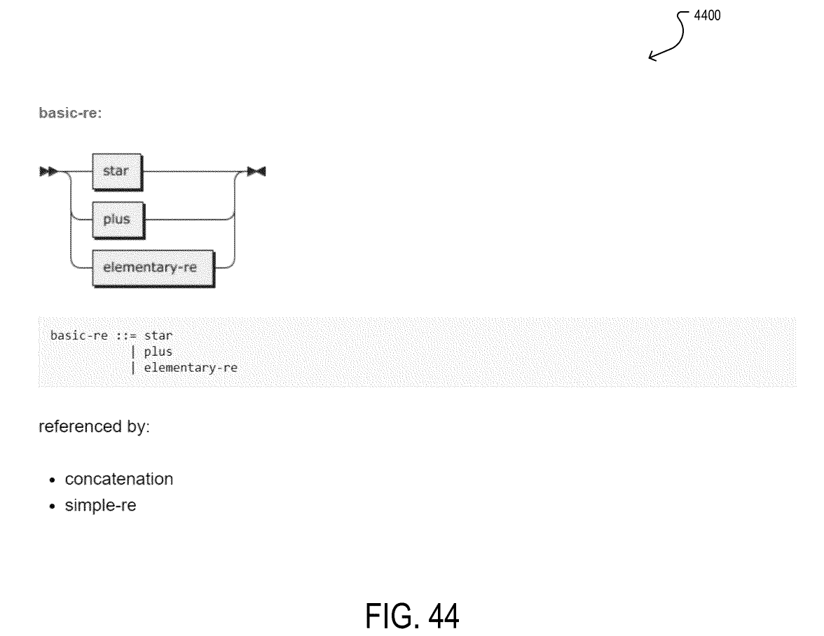

FIG. 44 shows an example EBNF diagram 4400 associated with basic-re according to an example of the instant disclosure.

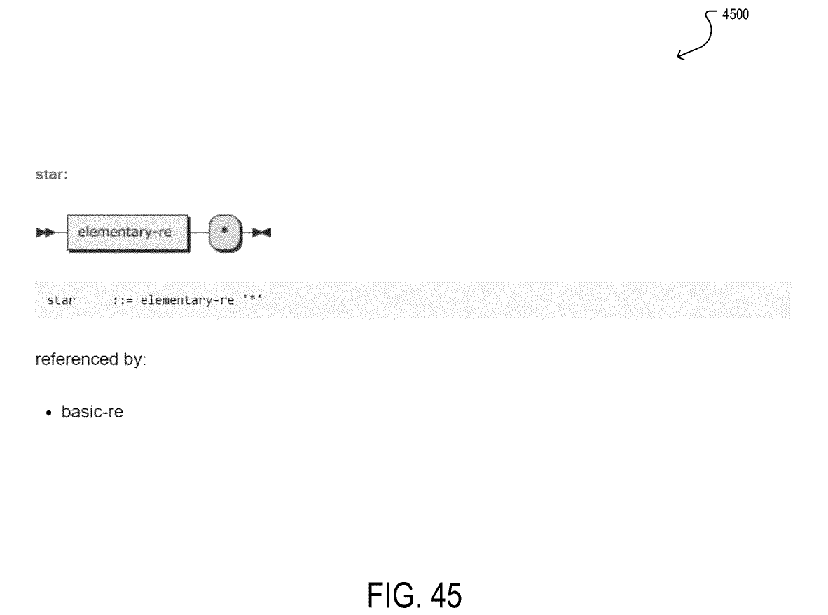

FIG. 45 shows an example EBNF diagram 4500 associated with star according to an example of the instant disclosure.

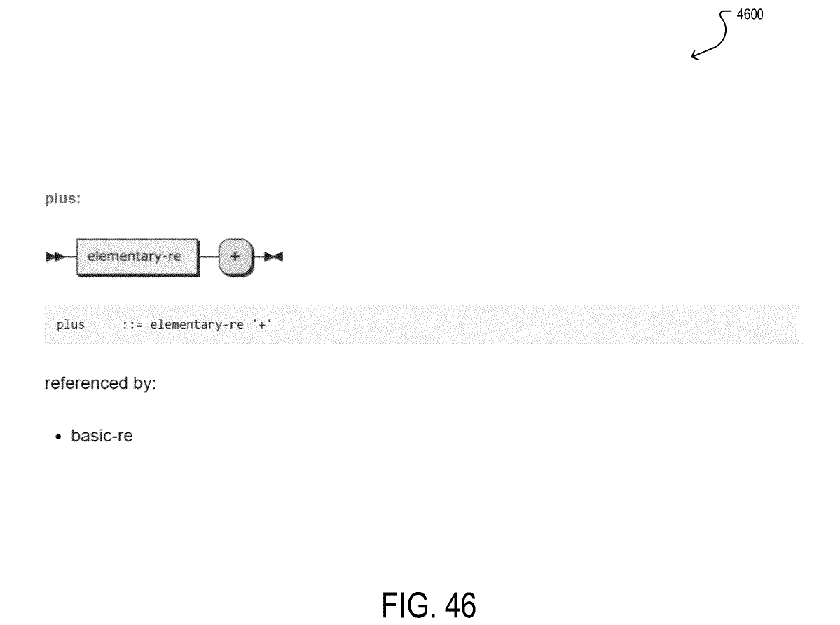

FIG. 46 shows an example EBNF diagram 4600 associated with plus according to an example of the instant disclosure.

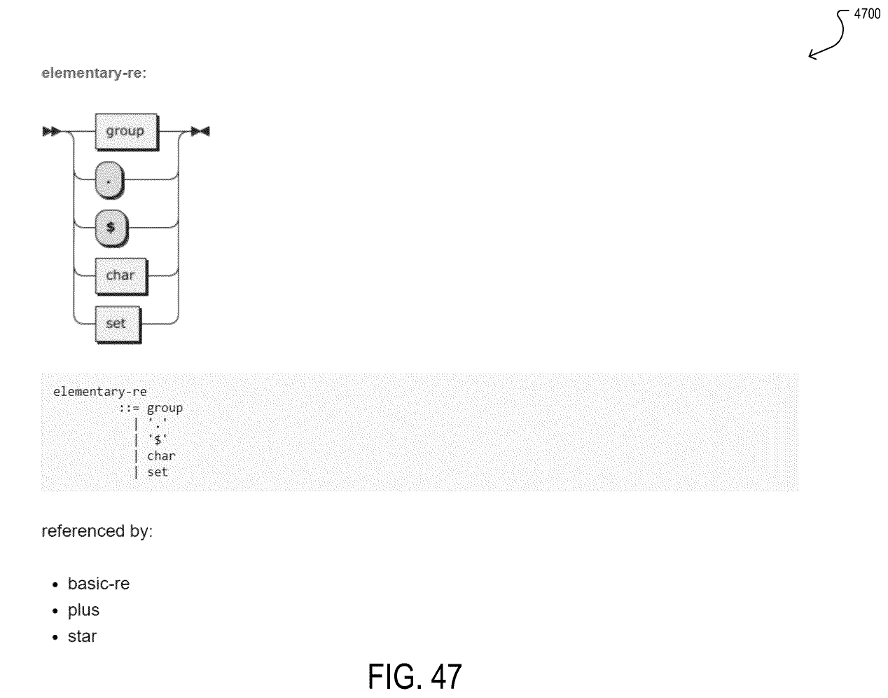

FIG. 47 shows an example EBNF diagram 4700 associated with elementary-re according to an example of the instant disclosure.

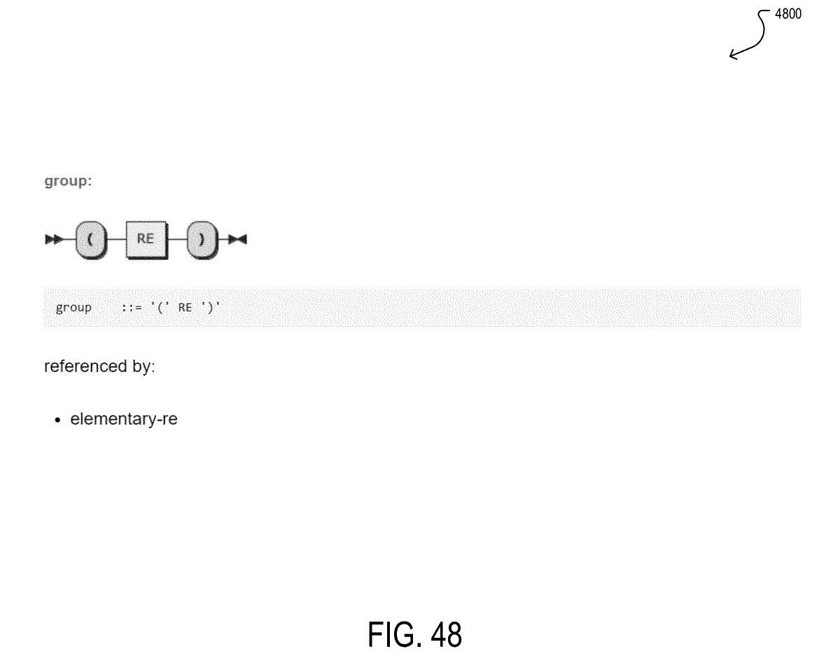

FIG. 48 shows an example EBNF diagram 4800 associated with group according to an example of the instant disclosure.

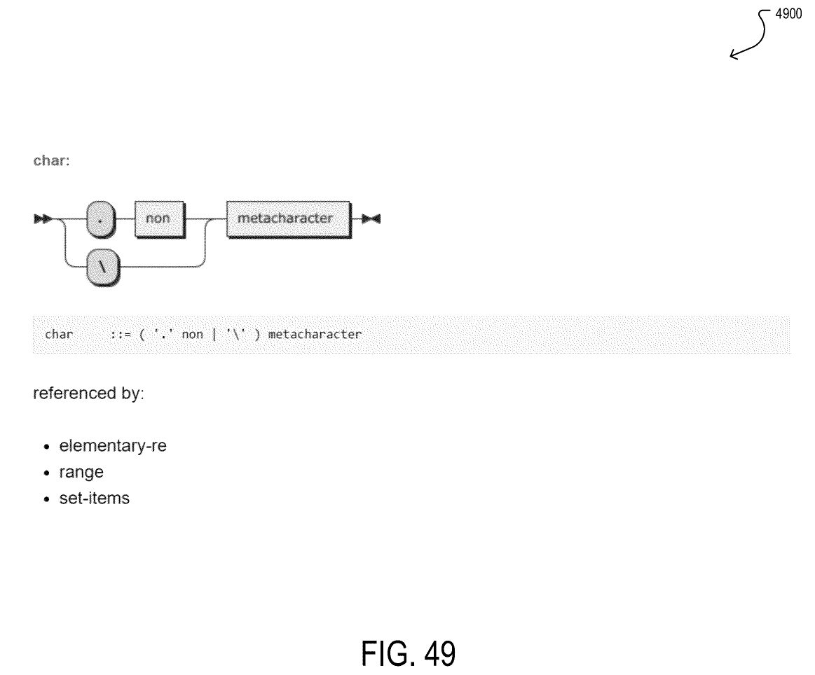

FIG. 49 shows an example EBNF diagram 4900 associated with char according to an example of the instant disclosure.

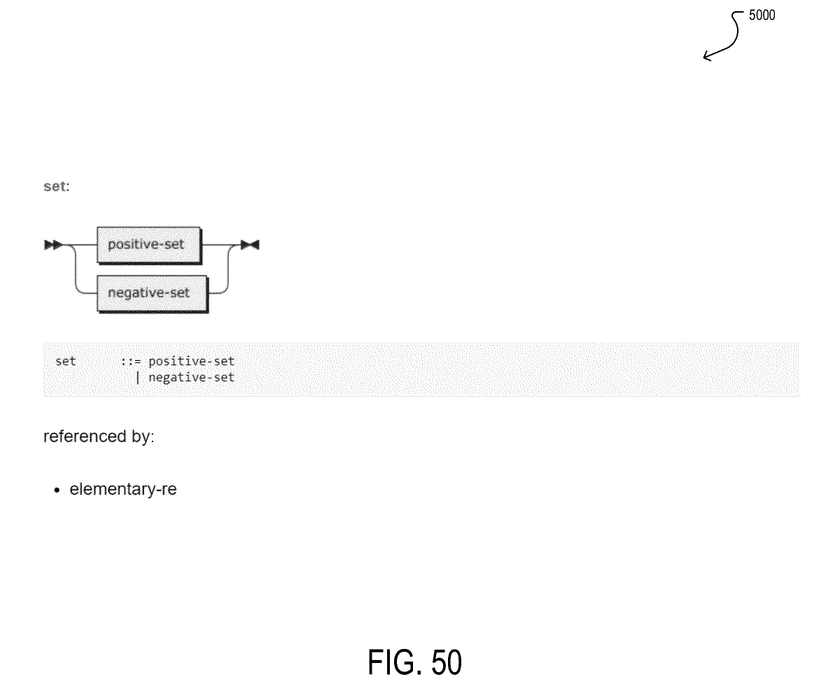

FIG. 50 shows an example EBNF diagram 5000 associated with set according to an example of the instant disclosure.

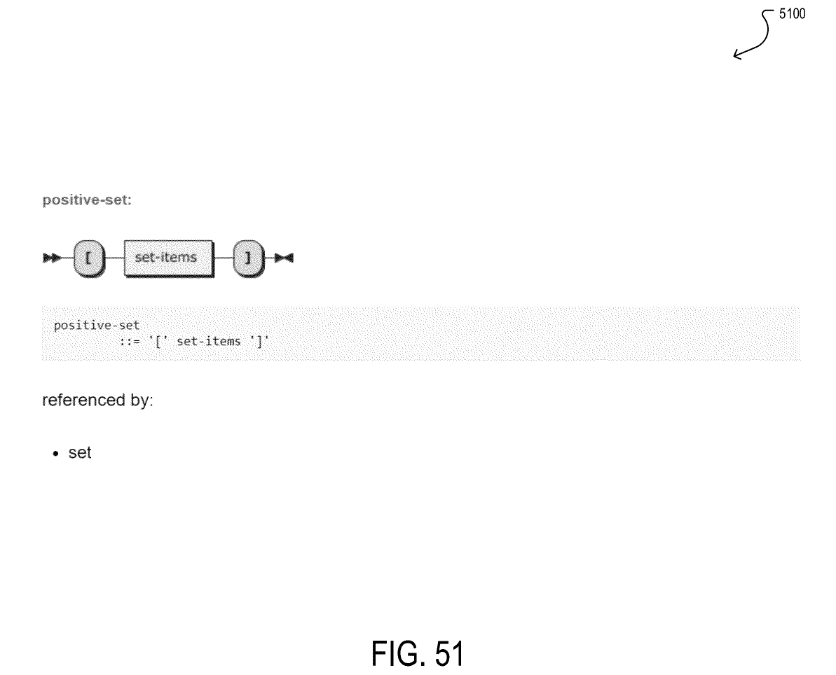

FIG. 51 shows an example EBNF diagram 5100 associated with positive-set according to an example of the instant disclosure.

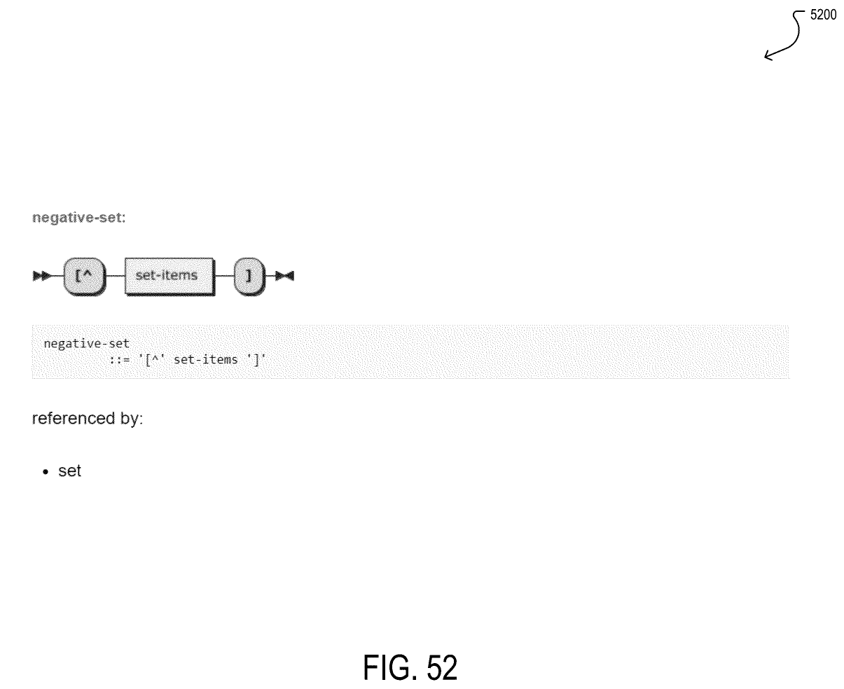

FIG. 52 shows an example EBNF diagram 5200 associated with negative-set according to an example of the instant disclosure.

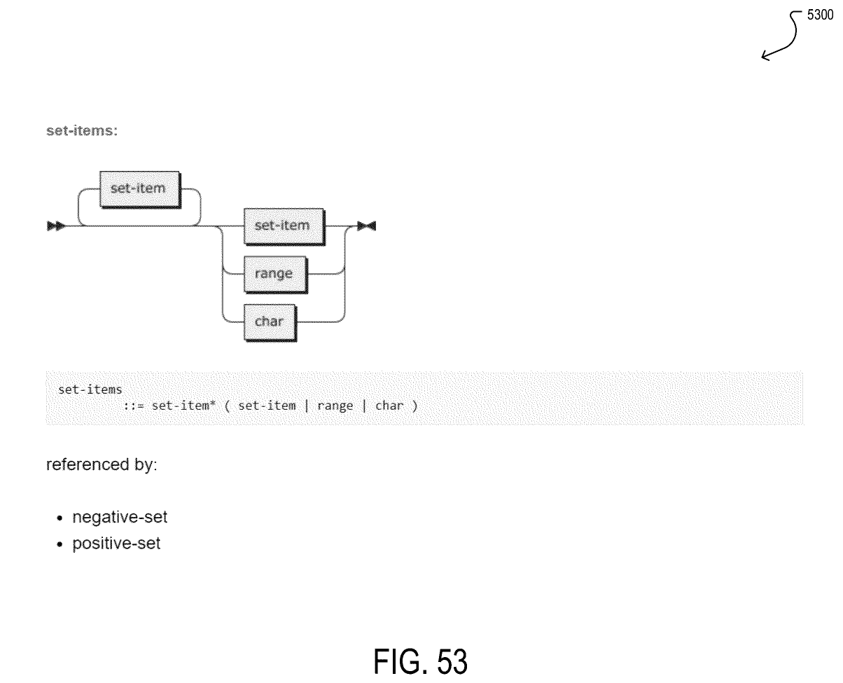

FIG. 53 shows an example EBNF diagram 5300 associated with set-items according to an example of the instant disclosure.

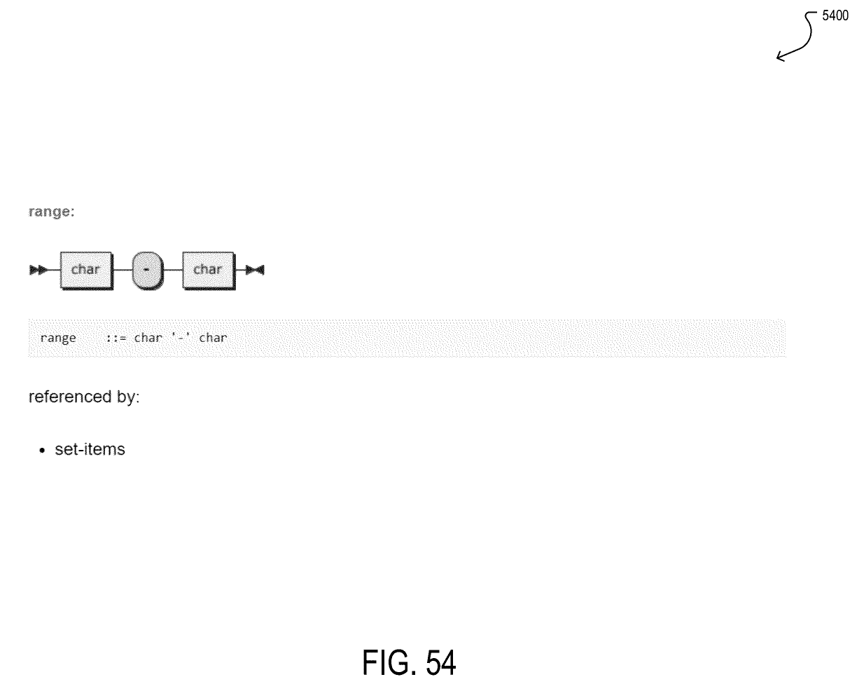

FIG. 54 shows an example EBNF diagram 5400 associated with range according to an example of the instant disclosure.

Usage

Vera 1208 utilizes a declarative language as noted herein to provide features not found in contemporary systems. In this section, some features are discussed. The examples include two parts, separated by [symbol] 1) a declaration, and 2) the resulting value from evaluating that declaration.

Basic Data and Metadata

The most basic use of Vera 1208 is to provide primary and intermediary values. To create the atom [symbol] and give it the value [symbol] , it is possible express the declaration with an opening parenthesis [symbol] , a question mark [symbol] , a space, the name [symbol] , a space again, the value [symbol] [symbol] , and a closing parenthesis [symbol] , like so:
($FOO Foo Bar Baz)

The name of the atom is not case-sensitive, so [symbol] , [symbol] , and [symbol] all refer to the same atom. To “retrieve” the value, one expresses it like so:
($FOO)

With these building blocks, it is possible to move on to creating more practical use cases.

```
      ($WALT Walt Disney) => Walt Disney
      ($WALT) => Walt Disney
      ($LILLIAN Lillian Disney) => Lillian Disney
      ($WALT :wife ($LILLIAN)) => Lillian Disney
      ($WALT :birthday 1901) => 1901
      ($WALT :birthplace ($CHICAGO Chicago, IL)) => Chicago, IL
      ($WALT) => ($WALT Walt Disney :wife ($LILLIAN)
:birthday 1901 :birthplace ($CHICAGO Chicago, IL)) => Walt Disney
      ($WALT :wife) => Lillian Disney
      ($WALT :birthday) => 1901
      ($WALT :birthplace) => Chicago, IL
```

Here, a new atom is created named [symbol] and it is given a value. The next line recalls that value. The same applies with the atom named [symbol] . In line 4, a metadata is created named [symbol] and given the value of the value stored in the atom [symbol] , which is [symbol] [symbol] . Additional metadata is created in the next two lines, then the complete set of data stored under the atom [symbol] . The same applies to the remaining declarations.

Abstraction with Metadata

It is also possible to build declarations that mutually depend on each other.

```
      ($DONALD Donald Duck :gf ($DAISY Daisy Duck)) =>
($DONALD Donald Duck :gf ($DAISY Daisy Duck)) => Donald Duck
      ($DAISY) => ($DAISY Daisy Duck) => Daisy Duck
      ($DAISY :bf ($DONALD)) => Donald Duck
      ($DONALD) => Donald Duck
      ($DONALD :gf) => Daisy Duck
      ($DAISY) => Daisy Duck
      ($DAISY :bf) => Donald Duck
      ($DONALD Donald Darling Duck)
      ($DAISY :bf) => Donald Darling Duck
```

Here, an atom is defined, but a metadata is added whose value is itself a declaration. In line 3, the [symbol] to be another declaration. At this point, [symbol] points to a declaration which has a reference back to [symbol] . Vera can correctly identify declarations that refer to each other, while maintaining reflexivity.

Abstraction with Embedded Data

Another thing that can be done with metadata is applying operations to them, while recalling metadata from other declarations.
($WALT :birthplace Chicago, IL/[\hat{ },]+/)=>Chicago
($WALT :birthplace Baton Rouge, LA)=>Baton Rouge, LA
($WALT :city ($WALT :birthplace)/[\hat{ },]+/)=>Baton Rouge
($WALT :birthplace Chicago, IL)=>Chicago, IL
($WALT :city)=>Chicago

Line 1 defines the metadata [symbol] for [symbol] , whose value is [symbol] Immediately after it is a pair of [symbol] for regex matching string. After defining [symbol] to [symbol] [symbol] , the regex [symbol] is applied to it, returning [symbol] . In line 2, the :birthplace is completely supplanted with a new value. In line 3, the metadata city is being assigned the value of recalling the value for [symbol] while applying the regex [symbol] . The next lines are basic assignments and recall. The remaining declarations recall those values.

Chaining of Regular Expressions

Chaining together regular expressions is possible both on the top- and metadata-level.
($SANDY-CITY San Diego, CA/[\hat{ },]+/Saint Diego)=>Saint Diego, CA
($WINDY-CITY Chicago, IL/[\hat{ },]+//cago/-Town)=>Chi-Town
($WINDY-CITY)=>Chi-Town

Here an atom is created named [symbol] and immediately replaces San Diego with Saint Diego. The text after the pair of [symbol] indicates the replacement from the one matched earlier. Next, an atom is created named [symbol] and given the primary value [symbol] . The regex is applied [symbol] to limit everything before the [symbol] , then match again with [symbol] , then finally replace that match with [symbol] .

Vega is a data storage system that includes two subsystems:
The Object subsystem: for storing and restoring lisp data (like integers, lists, CLOS instances, etc.)
The BLOB subsystem: for storing and later accessing binary data in a more uniform way

Setup

Development

For development purposes, it is possible to load the [symbol] script that will load the [symbol] system with debugging options enabled and then will run tests.

Regular Usage

For regular usage, it is possible to enable storage backends that will be loaded and enabled at compile time. There are two available storage backends for each Vega subsystem, and at least one can be enabled for each subsystem.

The Object Subsystem:
CL-USER>(pushnew :vega-object-file-backend *features*); the file based storage backend
CL-USER>(pushnew :vega-object-sqlite-backend *features*); the SQLite storage backend

The BLOB Subsystem:
CL-USER>(pushnew :vega-blob-file-backend *features*); the file based storage backend
CL-USER>(pushnew :vega-blob-sqlite-backend *features*); the SQLite storage backend

Then, the Vega system can be loaded as usual:
CL-USER>(asdf:load-system :vega)
CL-USER>(asdf:test-system :vega); you can optionally run tests

For convenience, it is possible to optionally switch to the [symbol] package that already imports all public symbols from [symbol] package. Vega API symbols do not have to be qualified.
CL-USER>(in-package:vega-user)
#<The VEGA-USER package, 0/16 internal, 0/16 external>

Usage

Getting Documentation Strings

All exported public classes, methods, and functions are documented. It is possible to get docstrings with the [symbol] function:
VEGA-USER>(documentation ‘store-object’function)
“Stores a lisp OBJECT in the object storage with NAME
Returns T if the OBJECT with the same NAME has been updated, or NIL otherwise.”
VEGA-USER>(documentation ‘restore-object’function)
“Restores a lisp object from the object storage with NAME.
Returns two values. The first value is a lisp object if found, or NIL otherwise. The second value is T if object with NAME is found; otherwise NIL.”
VEGA-USER>(documentation ‘delete-object’function)
“Deletes a stored lisp object from the object storage with NAME
Returns T if the object was actually deleted and NIL otherwise.”
VEGA-USER>(documentation ‘store-blob’function)
“Loads data from the SOURCE and stores it in the blob storage.
The SOURCE can be either a PATHNAME, a STRING or an OCTET-VECTOR.
Returns two values. The first value is the BLOB, and the second value, T, is if a new BLOB has been saved; otherwise, NIL if the BLOB already exists in the blob storage.”
VEGA-USER>(documentation ‘restore-blob’function)
“Restores data from the BLOB.
Returns the binary data from the blob storage if it exists. Returns NIL otherwise.”
VEGA-USER>(documentation ‘delete-blob’function)
“Deletes the BLOB from storage. Returns T if the BLOB was actually deleted and NIL otherwise.

Initialization

By default, Vega has the following working directory that is used for storage purposes:
VEGA-USER>(work-directory)
#P“/var/lib/vega/”

The user may have no permissions to access this directory, so the user can change this directory temporally for the current REPL session as follows:

```
      VEGA-USER> (setf (work-directory) (asdf:system-source-directory
(asdf:find-system :vega)))
      #P“/home/user/.quicklisp/local-projects/vega/”
      VEGA-USER> (work-directory)
      #P“/home/user/.quicklisp/local-projects/vega/”
```

or, it is possible to use the following macro with each call to Vega subsystems (which is less convenient but sometimes useful):

```
      VEGA-USER> (with-work-directory ((asdf:system-source-
directory (asdf:find-system :vega))) (work-directory))
      #P“/home/user/.quicklisp/local-projects/vega/”
```

To make it easier, for the usage examples, assume a temporally changed working directory with the [symbol] form.

[symbol]

At runtime, it is possible to initialize and work with only one backend for each subsystem and switch between them once the previously initialized backend has been shutdown.

Let's initialize the SQLite backend for the Object subsystem and the file-based storage for the BLOB subsystem:
VEGA-USER>(initialize-object-storage :sqlite); No value
VEGA-USER>(initialize-blob-storage :file); No value

To optionally check the initialization status of the Vega subsystems, use the following calls:
VEGA-USER>(object-storage-initialized-p):SQLITE
VEGA-USER>(blob-storage-initialized-p):FILE

Shutdown

When done working with the Vega data storage, it is desirable to shutdown all its subsystems to make sure all pending writes and/or transactions are finished with the following calls that match initialization ones:
VEGA-USER>(shutdown-object-storage); No value
VEGA-USER>(shutdown-blob-storage); No value

```
      Storing and restoring objects
      Let's store a list of some CLOS objects:
      VEGA-USER> (defclass person ( )
      ((first-name :initarg :first-name:reader first-name)(last-name :initarg
:last-name:reader last-name)(age :initarg :age:accessor age:type
(integer 0))))
      #<STANDARD-CLASS PERSON 4010215BB3>
      VEGA-USER> (defclass employee (person)
      ((department :initarg :department
      :accessor department)
      (salary :initarg :salary
      :accessor salary
      #<STANDARD-CLASS EMPLOYEE 40100D6EAB>
      VEGA-USER> (store-object (list
      (make-instance ′employee:first-name “John” :last-name “Doe”
        :age 25 :department “R&D” :salary 150000)
                    (make-instance ′employee
                            :first-name “Jane” : last-name “Doe”
                            :age 21
                            :department “HR” :salary 100000))
                    “list-of-employees”)
      NIL
```

The [symbol] returned [symbol] , meaning that there was not any object previously stored under the same name, [symbol] . If calling [symbol] again with the same name, it will overwrite the previously stored object and return [symbol] .

To restore the previously stored object with the name [symbol] :

VEGA-USER> (restore-object “list-of-employees”)
(#<EMPLOYEE 40100FF27B> #<EMPLOYEE 40100FF2C3>)
T
VEGA-USER> (describe (first *))
#<EMPLOYEE 40100FF27B> is an EMPLOYEE
DEPARTMENT “R&D”
SALARY 150000
FIRST-NAME “John”
LAST-NAME “Doe”
AGE 25
; No value
VEGA-USER> (describe (second **))
#<EMPLOYEE 40100FF2C3> is an EMPLOYEE
DEPARTMENT “HR”
SALARY 100000
FIRST-NAME “Jane”
LAST-NAME “Doe”
AGE 21
; No value

To store and then restore the hash-table that contains other objects:

```
      VEGA-USER> (let ((ht (make-hash-table :test #′equal)
            (setf (gethash “numbers” ht) (list 1123 pi 3/4 2.344
37882378927358723857289375892735897289357982375892735 #c(1 -5))
                (gethash “strings” ht) (vector “hello” “ [symbol]  ”)
                (gethash “conses” ht) (list (cons l ′one) (list 1 2 3) “hello” ′there)
                (gethash “arrays” ht) (vector (make-array ′(2 2) :initial-contents ′((1 2) (3
4)))
                                (make-array ′(2 2 2) :initial-contents ′(((1 2) (3 4)) ((5 6)
(7 8))))))
            (store-object ht “hashtable-of-objects”))
      NIL
      VEGA-USER> (let ((ht (restore-object “hashtable-of-objects”)))
            (describe ht))
      #<EQUAL Hash Table{4} 40100F888B> is a HASH-TABLE
      numbers (1123 3.141592653589793D0 3/4 2.344
37882378927358723857289375892735897289357982375892735 #C(1 -5))
      arrays #(#2A((1 2)(3 4)) #3A(((1 2) (3 4)) ((5 6) (7 8))))
      conses ((1 . ONE) (1 2 3) “hello” THERE)
      strings #(“hello” “ [symbol]  ”); No value
      To delete the previously stored object:
      VEGA-USER> (object-exists-p “list-of-employees”)
      T
      VEGA-USER> (delete-object “list-of-employees”)
      T
      VEGA-USER> (object-exists-p “list-of-employees”)
      NIL
      VEGA-USER> (restore-object “list-of-employees”)
      NIL
      NIL
```

The [symbol] function returns two values. The first value is a lisp object if found, or [symbol] otherwise. The second value is [symbol] if object with [symbol] is found; otherwise [symbol] . The returned values resemble the ones from the [symbol] function.

VEGA-USER> (store-object nil “just-nil”)
NIL
VEGA-USER> (restore-object “just-nil”)
NIL
T
VEGA-USER> (delete-object “just-nil”)
T
VEGA-USER> (restore-object “just-nil”)
NIL
NIL

Sometimes, it is desirable to control which slots to save and which to not save. For this particular case, use [symbol] metaclass:

```
VEGA-USER> (defclass abc ( )
      ((a :initarg :a)
        (b :initarg :b
        :storablep nil)
        (c :initarg :c))
      (:metaclass storable-object))
#<STORABLE-OBJECT ABC 401024CF9B>
VEGA-USER> (defclass def ( )
      ((d :initarg :d
        :storablep nil)
        (e :initarg :e)
        (f :initarg :f))
      (:metaclass storable-object))
#<STORABLE-OBJECT DEF 40100F5A03>
VEGA-USER> (store-object (make-instance ′abc
                    :a 111
                    :b 222
                    :c (make-instance ′def
                              :d 333
                              :e 444
                              :f 555))
            “storable-object”)
NIL
VEGA-USER> (restore-object “storable-object”)
#<ABC 4010204503>
T
VEGA-USER> (describe *)
#<ABC 4010204503> is an ABC
A 111
B #<unbound slot>
C #<DEF 401020453B>
; No value
VEGA-USER> (describe (slot-value ** ′c))
#<DEF 40C0024DFB> is a DEF
D #<unbound slot>
E 444
F 555
; No value
```

Storing and Restoring Blobs

To store an external file, an octet vector, or a string as a blob, one can use the [symbol] [symbol] function:

```
      VEGA-USER> (setq *b1* (store-blob #P“/usr/bin/ls”
      #<DATA-BLOB “67a3b1f956b8b786a983aa145293d861a5c528dc2174929f” 138208
application/octet-stream 40102FE4D3>
      VEGA-USER> (setq *b2* (store-blob “Hello World! [symbol] ”))
      #<DATA-BLOB “65d9a73a28553b9141cd018638aeca5d3alb70183f6e19be” 72
application/octet-stream 401010E903>
      VEGA-USER> (setq *b3* (store-blob (vector #xAB #xB1 #xFF)))
      #<DATA-BLOB “022322c8341a23c7aalf39abb0306671a2bbb76b211a39ba” 3
application/octet-stream 40102C5A33>
      VEGA-USER> (pprint (mapcar #′(lambda (b) (cons (blob-size b) (blob-hashsum b)))
                    (list *b1* * b2* * b3*)))
      ((138208 . “67a3b1f956b8b786a983aa145293d861a5c528dc2174929f”)
        (72 . 65d9a73a28553b9141cd018638aeca5d3a1b70183f6e19be”)
        (3 . 022322c8341a23c7aa1f39abb0306671a2bbb76b211a39ba”))
      ; No value
```

The [symbol] function accepts additional keywords that can specify a [symbol] (a string) and a content [symbol] (one of [symbol] , [symbol] , [symbol] , [symbol] or [symbol] ). Depending on the file's extension, the content TYPE can be automatically derived:

```
      VEGA-USER> (store-blob #P“ ./README.org”)
      #<TEXT-BLOB
      “242522f24a37f5f9fe37b1205abb8a6ed60b05d27d63359e” 11282
text/plain 40102070CB>
      T
      VEGA-USER> (blob-type *)
      :TEXT
      VEGA-USER> (blob-mimetype **)
      “text/plain”
```

The [symbol] function can be used to load the contents of a blob from the blob storage, which loads and then returns an octet vector if the blob exists. Otherwise, NIL will be returned:

```
      VEGA-USER> (length (restore-blob *b1*))
      138208
      VEGA-USER> (ef:decode-external-string (restore-blob *b2*) :utf-8)
      “Hello World! [symbol]  !”
      VEGA-USER> (restore-blob *b3*)
      #(171 177 255)
      Blobs can be compared with each other using the [symbol]    predicate. The
predicate [symbol]    can be used to compare a blob with the actual data it may have in the
blob storage:
      VEGA-USER> *b1*
      #<DATA-BLOB “67a3b1f956b8b786a983aa145293d861a5c528dc2174929f” 138208
application/octet-stream 40C019D16B>
      VEGA-USER> (blob-equal * #P“/bin/ls”)
      T
      VEGA-USER> (ef:decode-external-string (restore-blob *b2*) :utf-8)
      “Hello World! [symbol]  !”
      VEGA-USER> (blob-equal *b2* *)
      T
      VEGA-USER> (restore-blob *b3*)
      #(171 177 255)
      VEGA-USER> (blob-equal #(171 177 255) *b3*)
      T
      VEGA-USER> (blob-equal #(171 178 255) *b3*)
      NIL
      To delete a blob from the blob storage, use the [symbol]  function:
      VEGA-USER> (blob-exists-p *b1*)
      #P“/home/user/.quicklisp/local-
projects/vega/blobs/67/A3/67a3b1f956b8b786a983aa145293d861a5c528dc2174929f.blob”
      VEGA-USER> (delete-blob *b1*)
      T
      VEGA-USER> (blob-exists-p *b1*)
      NIL
      VEGA-USER> (delete-blob *b1*)
      NIL
      VEGA-USER> (restore-blob *b1*)
      NIL
      The [symbol]  can be used to lookup a stored blob by its [symbol]  :
      VEGA-USER> *b1*
      #<DATA-BLOB “67a3b1f956b8b786a983aa145293d861a5c528dc2174929f” 138208
application/octet-stream 4270313B5B>
      VEGA-USER> (find-blob (blob-hashsum *))
      NIL
      VEGA-USER> *b2*
      #<DATA-BLOB “65d9a73a28553b9141cd018638aeca5d3a1b70183f6e19be” 72
application/octet-stream 427031A8EB>
      VEGA-USER> (find-blob (blob-hashsum *))
      #<DATA-BLOB “65d9a73a28553b9141cd018638aeca5d3a1b70183f6e19be” 72
application/octet-stream 4010126F23>
      VEGA-USER> *b3*
      #<DATA-BLOB “022322c8341a23c7aa1f39abb0306671a2bbb76b211a39ba” 3
application/octet-stream 427031A903>
      VEGA-USER> (find-blob
“022322c8341a23c7aa1f39abb0306671a2bbb76b211a39ba”)
      #<DATA-BLOB “022322c8341a23c7aa1f39abb0306671a2bbb76b211a39ba” 3
application/octet-stream 401029339B>
```

It is possible to consider a more real usage example that combines [symbol] and [symbol] subsystems. In this example, the “large” text document will be divided into smaller chunks and stored as a list of blobs. It will use the object storage for storing a list of blob references and the blob storage to store the pieces of text.
(defparameter *large-text* “Lorem Ipsum dolor sit amet, consectetur adipiscing elit, sed do eiusmod
tempor incididunt ut labore et dolore magna aliqua. Ut enim ad minim veniam, quis nostrud
exercitation ullamco laboris nisi ut aliquip ex ea commodo consequat. Duis aute irure dolor in
reprehenderit in voluptate velit esse cillum dolore eu fugiat nulla pariatur. Excepteur sint
occaecat cupidatat non proident, sunt in culpa qui officia deserunt mollit anim id est laborum.
Lorem Ipsum dolor sit amet, consectetur adipiscing elit, sed do eiusmod tempor incididunt ut labore
et dolore magna aliqua. Ut enim ad minim veniam, quis nostrud exercitation ullamco laboris nisi ut
aliquip ex ea commodo consequat. Duis aute irure dolor in reprehenderit in voluptate velit esse
cillum dolore eu fugiat nulla pariatur. Excepteur sint occaecat cupidatat non proident, sunt in
culpa qui officia deserunt mollit anim id est laborum.
Lorem Ipsum dolor sit amet, consectetur adipiscing elit, sed do eiusmod tempor incididunt ut labore
et dolore magna aliqua. Ut enim ad minim veniam, quis nostrud exercitation ullamco laboris nisi ut
aliquip ex ea commodo consequat. Duis aute irure dolor in reprehenderit in voluptate velit esse
cillum dolore eu fugiat nulla pariatur. Excepteur sint occaecat cupidatat non proident, sunt in

| | |
|---|---|
| culpa qui officia deserunt mollit anim id est laborum.”) | |
| (defun save-text (text name &optional (chunk-size 50)) | |
| (let ((chunks | |
| (with-input-from-string (in text) | |
| (loop with chunks = (list) | |
| and chunk = (make-string chunk-size) | |
| for position = (read-sequence chunk in) | |
| while (plusp position) | |
| do (push (subseq chunk 0 position) chunks) | |
| finally (return (nreverse chunks)))))) | |
| (let ((blobs (mapcar #′store-blob chunks))) | |
| (pprint blobs) | |
| (store-object blobs name)))) | |
| VEGA-USER> (save-text *large-text* “large-text-as-list-of-chunks”) | |
| (#<DATA-BLOB “ac7900f44b49f4669d1902fa0e5f26c54b358fcee0dfde56” | 50 |
| application/octet-stream 42B07FFA0B> | |
| #<DATA-BLOB “1d6026d8c1e211afcfbc1aa5fe738c694b358fcee0dfde56” | 50 |
| application/octet-stream 42B07FFA23> | |
| #<DATA-BLOB “3ce6c7f860e8b73da2453403e9bcc1254b358fceeOdfde56” | 50 |
| application/octet-stream 42B07FFA3B> | |
| #<DATA-BLOB “dae01809bb2dd3e211a8e1454e96b6554b358fcee0dfde56” | 50 |
| application/octet-stream 42B07FFA53> | |
| #<DATA-BLOB “2a7390233f0b6c58b377b478f378ff954b358fcee0dfde56” | 50 |
| application/octet-stream 42B07FFA6B> | |
| #<DATA-BLOB “7d757d4711d6d06eac47d95fac4f499f4b358fceeOdfde56” | 50 |
| application/octet-stream 42B07FF9F3> | |
| #<DATA-BLOB “b33c6abca3ddcd9f3ef3a0063d07ea924b358fcee0dfde56” | 50 |
| application/octet-stream 4010022853> | |
| #<DATA-BLOB “2ea6543b89d61e3789b6e792fb84ae2c4b358fcee0dfde56” | 50 |
| application/octet-stream 40100352CB> | |
| #<DATA-BLOB “8cf5a68d2526b8e644604ad1ee5a1e5b4b358fcee0dfde56” | 50 |
| application/octet-stream 4010047D43> | |
| #<DATA-BLOB “69089ea6cb2634d7ad97257572bb029f4b358fcee0dfde56” | 50 |
| application/octet-stream 4010062853> | |
| #<DATA-BLOB “1dcbebbc167abe4cae02574e6461d05b4b358fcee0dfde56” | 50 |
| application/octet-stream 40100752CB> | |
| #<DATA-BLOB “c62459029a0f7a2f7e8cacdf649bc9b84b358fcee0dfde56” | 50 |
| application/octet-stream 4010087D43> | |
| #<DATA-BLOB “f1b7625e71f7cb265c990f349fd2988c4b358fcee0dfde56” | 50 |
| application/octet-stream 40100A2853> | |
| #<DATA-BLOB “457a2d35f585cbd227bfdc1914cc31c84b358fcee0dfde56” | 50 |
| application/octet-stream 40100B52CB> | |
| #<DATA-BLOB “c3085d3cc703e910f0f31847479886e04b358fcee0dfde56” | 50 |
| application/octet-stream 40100C7D43> | |
| #<DATA-BLOB “52a3c3ed4642571a8fe3ebfdc06b591f4b358fcee0dfde56” | 50 |
| application/octet-stream 40100E2853> | |
| #<DATA-BLOB “e33f5655a0000a27935f8322062360ae4b358fcee0dfde56” | 50 |
| application/octet-stream 40100F52CB> | |
| #<DATA-BLOB “e7ea41945607b83c1dcf251dca5ae6164b358fcee0dfde56” | 50 |
| application/octet-stream 4010107D43> | |
| #<DATA-BLOB “d16646dd1f6975615c3143d295ce6b8b4b358fcee0dfde56” | 50 |
| application/octet-stream 4010122853> | |
| #<DATA-BLOB “6f55e5bde8311c725d6b3060562c6bfc4b358fcee0dfde56” | 50 |
| application/octet-stream 40101352CB> | |
| #<DATA-BLOB “965c6050e484b8b30b9bbeffb90055504b358fcee0dfde56” | 50 |
| application/octet-stream 4010147D43> | |
| #<DATA-BLOB “d62a54479d0d70f2a7135951e2f2a4f94b358fceeOdfde56” | 50 |
| application/octet-stream 4010162853> | |
| #<DATA-BLOB “baeeb24c00dca5e3821826ac2a1162664b358fcee0dfde56” | 50 |
| application/octet-stream 40101752CB> | |
| #<DATA-BLOB “c0a369f993d341cff86384239782c61b4b358fcee0dfde56” | 50 |
| application/octet-stream 4010187D43> | |
| #<DATA-BLOB “e1c318f3b2805bad2e52774daabb12604b358fcee0dfde56” | 50 |
| application/octet-stream 40101A2853> | |
| #<DATA-BLOB “36c8758ca392cab63892bae535fcd77e4b358fcee0dfde56” | 50 |
| application/octet-stream 40101B52CB | |
| #<DATA-BLOB “adfbc12ddaace08f06a7016a62d39fc352736ba4147635e4” | 39 |
| application/octet-stream 40101C7D43>) | |
| NIL | |

Then it is possible to load this structure from the storage and process it, e.g. turning lowercase characters to uppercase ones and saving them back to the storage.

| | |
|---|---|
| (defun process-text (name) | |
| (let* ((blobs (restore-object name)) | |
| (chunks | |
| (mapcar #′(lambda (octets) (ef:decode-external-string octets :utf-8)) | |
| (mapcar #′restore-blob blobs))) | |
| (processed (mapcar #′string-upcase chunks))) | |
| (let ((blobs (mapcar #′store-blob processed))) | |
| (pprint blobs) | |
| (store-object blobs name)))) | |
| VEGA-USER> (process-text “large-text-as-list-of-chunks”) | |
| (#<DATA-BLOB “1da1c59e05456eb5a7e4f24e598e54cf4b358fcee0dfde56” | 50 |
| application/octet-stream 41301CCDBB> | |
| #<DATA-BLOB “521d5756680554bb328f2768d0a0c6244b358fcee0dfde56” | 50 |
| application/octet-stream 41301CCDEB> | |
| #<DATA-BLOB “ec7f655d26fe412f015758f7d339dcd84b358fcee0dfde56” | 50 |
| application/octet-stream 41301CCE03> | |
| #<DATA-BLOB “640e3d63631b953d254ee3b8e943415f4b358fcee0dfde56” | 50 |
| application/octet-stream 41301CCE1B | |
| #<DATA-BLOB “458f16c0c64cec931b01a211ffaa35be4b358fcee0dfde56” | 50 |
| application/octet-stream 41301CCE33> | |
| #<DATA-BLOB “7837bc31b853675d4bfdd8666a75495b4b358fcee0dfde56” | 50 |
| application/octet-stream 41301CCE4B> | |
| #<DATA-BLOB “de8917ff1973c0bfe7676de31bcf21444b358fcee0dfde56” | 50 |
| application/octet-stream 41301CCE63> | |
| #<DATA-BLOB “64bc6a75367442aebd73bfe710bada0c4b358fcee0dfde56” | 50 |
| application/octet-stream 41301CCE7B> | |
| #<DATA-BLOB “9d0ddf2ba65ab6a676f676a2dc4552124b358fcee0dfde56” | 50 |
| application/octet-stream 41301CCE93> | |
| #<DATA-BLOB “1810589aed59dd61a0cb929609d7eceb4b358fcee0dfde56” | 50 |
| application/octet-stream 41301CCEAB> | |
| #<DATA-BLOB “4e35bdd21b0d35e0b67e4b66658c837b4b358fcee0dfde56” | 50 |
| application/octet-stream 41301CCEC3> | |
| #<DATA-BLOB “01b05705f4e53fd2d3565c4a26876dff4b358fcee0dfde56” | 50 |
| application/octet-stream 41301CCEDB> | |
| #<DATA-BLOB “5f22df92985e83a4d7c0a0186c0bccdc4b358fcee0dfde56” | 50 |
| application/octet-stream 41301CCEF3> | |
| #<DATA-BLOB “d58d19bf8325406d54dee5e1e214d45d4b358fcee0dfde56” | 50 |
| application/octet-stream 41301CCF0B> | |
| #<DATA-BLOB “61f258a4b41068667ced1a377bc8b6474b358fcee0dfde56” | 50 |
| application/octet-stream 41301CCF23> | |
| #<DATA-BLOB “f77e5db7ff47b542b44332a691e13acc4b358fcee0dfde56” | 50 |
| application/octet-stream 41301CCF3B> | |
| #<DATA-BLOB “a26e80287d79315a0635fbb19eb465894b358fcee0dfde56” | 50 |
| application/octet-stream 41301CCF53> | |
| #<DATA-BLOB “e4c28e298f5d5f4750c661f3c6bab33b4b358fcee0dfde56” | 50 |
| application/octet-stream 41301CCF6B> | |
| #<DATA-BLOB “c5bb2738da12286844c6020c965c1d904b358fcee0dfde56” | 50 |
| application/octet-stream 41301CCF83> | |
| #<DATA-BLOB “aee9f7c615a13b434ab68a7439e5e1654b358fcee0dfde56” | 50 |
| application/octet-stream 41301CCF9B> | |
| #<DATA-BLOB “97abe2fcf6f405144f7290b801314c204b358fcee0dfde56” | 50 |
| application/octet-stream 41301CCDD3> | |
| #<DATA-BLOB “f16a19b6375bd217736a9395bd93620a4b358fcee0dfde56” | 50 |
| application/octet-stream 4010022853> | |
| <DATA-BLOB “4df0741c400d8d25dd4259a408ef31734b358fcee0dfde56” | 50 |
| application/octet-stream 40100352CB> | |
| <DATA-BLOB “eab57acb21ef535b4102b3c9508a7fb74b358fcee0dfde56” | 50 |
| application/octet-stream 4010047D43> | |
| #<DATA-BLOB “b5015d6c26d91fd58ed81221d7d5b9eb4b358fcee0dfde56” | 50 |
| application/octet-stream 4010062853> | |
| #<DATA-BLOB “92744eecf70f29f7a14b95d0c588f1104b358fcee0dfde56” | 50 |
| application/octet-stream 40100752CB> | |
| #<DATA-BLOB “cdef45320c52a26ad35eaf4bf1154e7452736ba4147635e4” | 39 |
| application/octet-stream 4010087D43>) | |
| T | |

And finally, load the whole text from the storage to test if it is possible to restore it fully.

```
      (defun load-text (name)
        (let* ((blobs (restore-object name))
            (chunks
            (mapcar #′(lambda (octets) (ef:decode-external-string octets :utf-8))
                (mapcar #′restore-blob blobs))))
        (with-output-to-string (out)
          (dolist (chunk chunks)
          (write-string chunk out)))))
      VEGA-USER> (load-text “large-text-as-list-of-chunks”)
      “LOREM IPSUM DOLOR SIT AMET, CONSECTETUR ADIPISCING ELIT, SED
DO EIUSMOD
      TEMPOR INCIDIDUNT UT LABORE ET DOLORE MAGNA ALIQUA. UT ENIM
AD MINIM VENIAM, QUIS NOSTRUD
      EXERCITATION ULLAMCO LABORIS NISI UT ALIQUIP EX EA COMMODO
CONSEQUAT. DUIS AUTE IRURE DOLOR IN
      REPREHENDERIT IN VOLUPTATE VELIT ESSE CILLUM DOLORE EU
FUGIAT NULLA PARIATUR. EXCEPTEUR SINT
      OCCAECAT CUPIDATAT NON PROIDENT, SUNT IN CULPA QUI OFFICIA
DESERUNT MOLLIT ANIM ID EST LABORUM.
      LOREM IPSUM DOLOR SIT AMET, CONSECTETUR ADIPISCING ELIT, SED
DO EIUSMOD TEMPOR INCIDIDUNT UT LABORE
      ET DOLORE MAGNA ALIQUA. UT ENIM AD MINIM VENIAM, QUIS
NOSTRUD EXERCITATION ULLAMCO LABORIS NISI UT
      ALIQUIP EX EA COMMODO CONSEQUAT. DUIS AUTE IRURE DOLOR IN
REPREHENDERIT IN VOLUPTATE VELIT ESSE
      CILLUM DOLORE EU FUGIAT NULLA PARIATUR. EXCEPTEUR SINT
OCCAECAT CUPIDATAT NON PROIDENT, SUNT IN
      CULPA QUI OFFICIA DESERUNT MOLLIT ANIM ID EST LABORUM.
      LOREM IPSUM DOLOR SIT AMET, CONSECTETUR ADIPISCING ELIT, SED
DO EIUSMOD TEMPOR INCIDIDUNT UT LABORE
      ET DOLORE MAGNA ALIQUA. UT ENIM AD MINIM VENIAM, QUIS
NOSTRUD EXERCITATION ULLAMCO LABORIS NISI UT
      ALIQUIP EX EA COMMODO CONSEQUAT. DUIS AUTE IRURE DOLOR IN
REPREHENDERIT IN VOLUPTATE VELIT ESSE
      CILLUM DOLORE EU FUGIAT NULLA PARIATUR. EXCEPTEUR SINT
OCCAECAT CUPIDATAT NON PROIDENT, SUNT IN
      CULPA QUI OFFICIA DESERUNT MOLLIT ANIM ID EST LABORUM.”
```

Implementation Overview

The Vega system includes two subsystems:
a higher-level extensible (via CLOS) interface to store [symbol] , [symbol] , [symbol] , etc.
a low-level internal interface for (re)storing lisp objects
an interface to store blobs (large texts, videos, music, etc.)

Implementation Proposal

Storing [symbol] , [symbol] , [symbol] , etc.

Storing Lisp Objects

Lisp objects are serialized and deserialized into and from bytes that are then written and read from a file or database.

Storing Blobs (Texts, Videos, Images, Etc.)

Large text, video, music, and other binary data (blobs) are stored directly on a file system or database. Blobs then can be retrieved by their hash sum (which is used as a unique name): by a filename if stored on a filesystem or a name if stored in a database.

For hashing binary data, [symbol] can be used due to its extremely fast non-cryptographic hash algorithm, working at RAM speed limit (for large and small data), and quality of hash functions.

Database as a Storage Backend

SQLite is used as a storage backend due to its small footprint, efficiency, and general availability on desktop and wearable systems.

Filesystem as a Storage Backend

The directory structure of a file-based blob storage has the following layout:

This layout allows the system to have more inodes available when storing massive amounts of binary files as blobs and faster lookups by a hashsum.

The first few bytes (derived from blobs' hashsums) are the names of nested directories, which are blobs' locations and would be calculated as follows:
the [symbol] hash of the file, e.g. [symbol] would be [symbol]
the [symbol] hash of the file's size: e.g. 640 Mb would be [symbol]
the [symbol] operation of [symbol] would be:

[symbol]

It is possible to use the first few bytes (e.g., two) of the final hash as nested directories to store a blob: eb/56/2c26e3573ecfee55578183d097df52525df9ffafb5ce

The last step (4) is needed to avoid hash collisions because the first few bytes are used to determine a blob's directory pathname.

Vela

Overview

Vela or the data gathering module 1210 can gather data from different data sources, including, but not limited to text, video, and audio, found on the internet, local networks, and disks. When used over networks like the internet, the data gathering module 1210 works by collecting information across publicly available sources like wikis, spreadsheets, corpora, and other public domain resources. When used over intranets, the data gathering module 1210 works by ingesting pre-existing data sets from private sources like company documents and open directories.

Vela or the data gathering module 1210 works as a passive service and collects data within the constraints that were specified prior to running the data gathering module 1210.

Xavier

Overview

Xavier or the user interface module 1212, or X, is the human-machine interface for receiving commands in the form of text keywords and voice data, and dispatching commands based on the input. With the textual interface, the user interface module 1212 listens for commands as text, buffers the text, then sends the commands to the appropriate subsystem or module of the data analysis and discovery application 106. As a voice interface, the user interface module 1212 listens for voice commands, converts the voice commands into text, and dispatches commands.

When used with the textual interface, it listens on a network port for commands, processes them, then sends back the results of the query in the form of text blobs. This is the default interface when used by developers and backend engineers, since it returns the raw information which contains other data like metadata.

When used with the voice interface, the voice command is first converted to text, and the text is sent down the wire just like with the textual interface, but instead of returning text blobs, the results are presented in a graphical user interface (GUI). The voice interface works by loading an application—whether web based or mobile—that continually listens for commands in the form of keywords. Each successive keyword refines the result that will be shown on the screen, as a compound live image that can be interacted with via keyboard, mouse, or touch. Predefined control keywords—“stop” and “resume”—are set up so that results will be delivered fluidly and in real time. This removes the necessity to use an explicit “Ok” or “Submit” button.

When instantiated as a mobile application, X can passively listen to voice commands. An example interaction would be: “X, pasta, Jane Doe, red motorcycle, last week, stop” In that sequence, Xavier is first called to attention with the keyword “X,” then the remaining words are keyword commands. When a user says “pasta” the screen shows the most recent information about pasta relative to you, and when you say “Jane Doe,” the screen is updated with items that pertain to both “pasta” and “Jane Doe.” When you reached “stop” the screen pauses the updates, and freezes the information presented on the screen, then you can select from the results the information that you most likely want to extract. If for example, you have already found what you were looking for after you said “red motorcycle,” you can already tap the results from the screen and get the information that you want.

Other Systems

Marie

In order to facilitate the delivery of common code across the sub-systems, dedicated libraries that provide subroutines have to be used. Marie 1302 is a collection of functions that have no external dependencies, i.e., all the functionality contained inside Marie 1302 do not depend on libraries written by other people. Pierre 1302, on the other hand, is a collection of functions, just like Marie 1302, but it depends on third-party software.

The separation of code between these components are designed so that it is clear which component relies on the work of others, in order to evaluate the possibility of implementing those functionality ourselves.

Doadm

Doadm 1306 is both the command line program and library for administering resources on DigitalOcean servers. It supports the creation, updating, deletion, and status retrieval of droplets. The same set of operations are also available for databases, firewalls, and domain names.

Remote servers—droplets—are used for the deployment of machines to serve instance of Valmiz or specific components of it.

Vgadm

Vgadm 1304 is a command line program for administering virtual machines (VMs). Vgadm 1304 uses Vagrant and VirtualBox to manage local VMs. Just like Doadm 1306, Vgadm 1304 supports the creation, updating, deletion, and status retrieval of VMs. Just like Doadm 1306, Vgadm 1304 can support the creation, updating, deletion, and status retrieval of VMs.

Locally-managed virtual machines are used for managing private instances of the data analysis and discovery application 106, especially where privacy and confidentiality of information is paramount. Vgadm 1304 is primarily used for sites that are not connected to the internet.

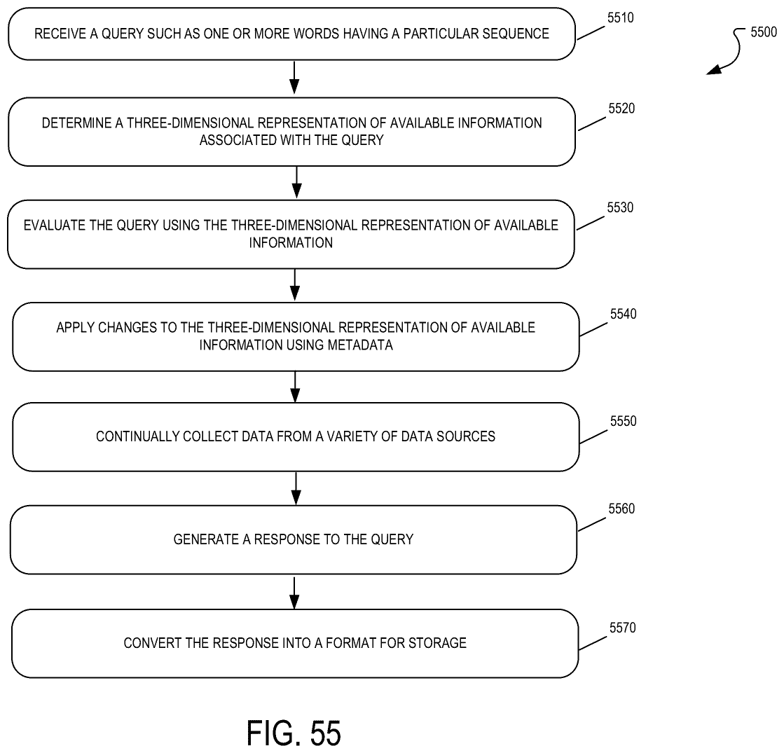

FIG. 55 illustrates an example method 5500 of receiving a query and providing results associated with the query according to an example of the instant disclosure. Although the example method 5500 depicts a particular sequence of operations, the sequence may be altered without departing from the scope of the present disclosure. For example, some of the operations depicted may be performed in parallel or in a different sequence that does not materially affect the function of the method 5500. In other examples, different components of an example device or system that implements the method 5500 may perform functions at substantially the same time or in a specific sequence.

According to some examples, the method 5500 may include receiving a query at block 5510. As an example, the query may be a text-based query such as one or more words. As another example, the query may be a voice-based query such as one or more spoken words or a voice-based query. The one or more words may have a particular sequence. As an example, the method 5500 may include evaluating the query in realtime as the one or more words are received. As another example, the method 5500 may include receiving the query via one of a web application programming interface (API) and a local API.

According to some examples, the method 5500 may include determining a three-dimensional representation of available information associated with the query based on a plurality of information banks, each information bank comprising a layer of available information associated with the query. The plurality of information banks may include a number of information banks from information bank 1 to information bank n. In one example, an instance of data in the plurality of information banks can be associated with at least one other instance of data using a symmetrical binding. In another example, an instance of data in the plurality of information banks can be associated with at least one other instance of data using one of a fixed anchor, a movable anchor, and a cascading anchor. As another example, the plurality of information banks may include a plurality of data layers.

Next, according to some examples, the method 5500 may include evaluating the query at block 5530. The result of the evaluating may include sending the query to Veda or the data ingestion module 1206 for processing of the query. As an example, the evaluating may include using the three-dimensional representation of available information, the three-dimensional representation of available information having a plurality of terms, each term comprising an identifier, a value, and zero or more related terms. In some examples, at least one term has a nested term within.

Next, according to some examples, the method 5500 may include additional processing by the metadata module 1208 or Vera at block 5540. As noted herein, the metadata module 1208 may track key-value-metadata changes. As a result, the evaluating may adapt to changes based on changes tracked by the key-value-metadata changes. In other words, the method 5500 may apply changes to the three-dimensional representation of available information using metadata.

Next, according to some examples, the method 5500 may include additional processing by the data gathering module 1210 or Vela at block 5550. As noted herein, the data gathering module 1210 may obtain data from a variety of data sources and this may be used to continually collect data from the sources to provide a response to queries. As a result, the evaluating may adapt to changes based on new sources of data. In other words, the method 5500 may include continually collecting data from a variety of data sources to supplement the three-dimensional representation of available information.

Next, according to some examples, the method 5500 may include generating a response to the query at block 5560. In one example, the response to the query may include an information block. The response to the query may be a result of the evaluating. The data ingestion module 1206 may utilize raw data from a variety of sources that is converted into indexable knowledge stores including comma-separated value (CSV) data, spreadsheet data, JSON files, and JSON streams. The data ingestion module 1206 may create a semantic network that is based on available data sources. In one example, the semantic network may be a three-dimensional representation of available information. As an example, the response to the query may be a term including at least one of at least one word, a value, and metadata.

Next, according to some examples, the method 5500 may include converting the response to the query into a format for storage at block 5570, the format including one of textual representation, binary representation, and a database representation. As another example, the format may be an object representation of a declaration comprising an identifier, a primary value, and at least one metadata key-value pair. As an example, the response may be stored as a textual representation, including S-Exps, XML, JSON, YAML. In addition, the information may be stored as a binary representation such as a binary file, a full Lisp heap dump, or a memory-mapped file. In addition, the information may be stored in the database 110.

According to some examples, the method 5500 may include transmitting the response to the query to the client computing device 102.

According to some examples, the method 5500 may include transmitting the response to the query to be displayed on a display by a graphical user interface (GUI).

According to some examples, the method 5500 may include fusing the plurality of information banks to create the three-dimensional representation. As an example, the three-dimensional representation may be a plurality of three-dimensional data blocks. wherein

According to some examples, the method 5500 may include receiving the query in a language formatted for the system.

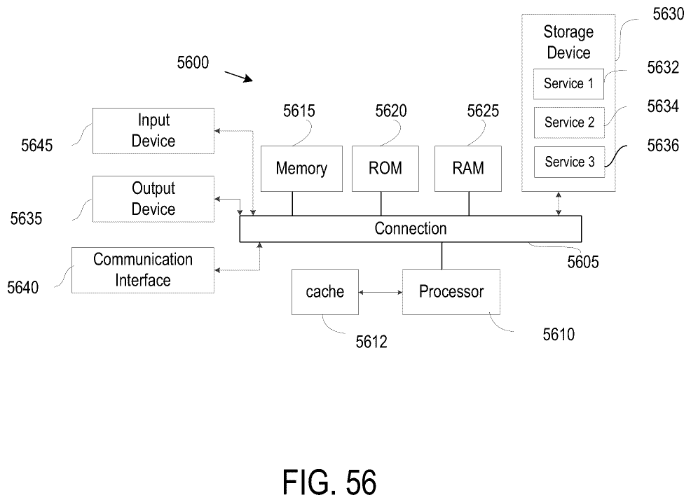

FIG. 56 shows an example of computing system 5600, which can be, for example, any computing device making up the computing device such as the client computing device 5602, the server computing device 104, or any component thereof in which the components of the system are in communication with each other using connection 5605. Connection 5605 can be a physical connection via a bus, or a direct connection into processor 5610, such as in a chipset architecture. Connection 5605 can also be a virtual connection, networked connection, or logical connection.

In some embodiments, computing system 5600 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 5600 includes at least one processing unit (CPU or processor) 5610 and connection 5605 that couples various system components including system memory 5615, such as read-only memory (ROM) 5620 and random access memory (RAM) 5625 to processor 5610. Computing system 5600 can include a cache of high-speed memory 5612 connected directly with, in close proximity to, or integrated as part of processor 5610.

Processor 5610 can include any general purpose processor and a hardware service or software service, such as services 5632, 5634, and 5636 stored in storage device 5630, configured to control processor 5610 as well as a special-purpose processor where software instructions are incorporated into the actual processor design. Processor 5610 may essentially be a completely self-contained computing system, containing multiple cores or processors, a bus, memory controller, cache, etc. A multi-core processor may be symmetric or asymmetric.

To enable user interaction, computing system 5600 includes an input device 5645, which can represent any number of input mechanisms, such as a microphone for speech, a touch-sensitive screen for gesture or graphical input, keyboard, mouse, motion input, speech, etc. Computing system 5600 can also include output device 5635, which can be one or more of a number of output mechanisms known to those of skill in the art. In some instances, multimodal systems can enable a user to provide multiple types of input/output to communicate with computing system 5600. Computing system 5600 can include communications interface 5640, which can generally govern and manage the user input and system output. There is no restriction on operating on any particular hardware arrangement, and therefore the basic features here may easily be substituted for improved hardware or firmware arrangements as they are developed.

Storage device 5630 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 5630 can include software services, servers, services, etc., that when the code that defines such software is executed by the processor 5610, it causes the system to perform a function. In some embodiments, a hardware service that performs a particular function can include the software component stored in a computer-readable medium in connection with the necessary hardware components, such as processor 5610, connection 5605, output device 5635, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

What is claimed is:

1. A system comprising:
a memory storing computer-readable instructions; and
at least one processor to execute the instructions to:
receive a query comprising one or more words having a particular sequence;
determine a three-dimensional representation of available information associated with the query based on a plurality of information banks, each information bank comprising a layer of available information associated with the query;
evaluate the query using the three-dimensional representation of available information associated with the query, the three-dimensional representation of available information having a plurality of terms, each term comprising an identifier, a value, and zero or more related terms;
generate a response to the query using the three-dimensional representation of available information; and
convert the response to the query into a format for storage.

2. The system of claim 1, the at least one processor further to execute the instructions to:
apply changes to the three-dimensional representation of available information using metadata; and
continually collect data from a variety of data sources to supplement the three-dimensional representation of available information.

3. The system of claim 1, the at least one processor further to execute the instructions to receive the query as a text-based query.

4. The system of claim 1, the at least one processor further to execute the instructions to receive the query as a voice-based query.

5. The system of claim 1, the at least one processor further to execute the instructions to evaluate the query in realtime as the one or more words are received.

6. The system of claim 1, the at least one processor further to execute the instructions to transmit the response to the query to a client computing device.

7. The system of claim 1, the at least one processor further to execute the instructions to transmit the response to the query to be displayed on a display by a graphical user interface (GUI).

8. The system of claim 1, wherein the format for storage comprises at least one of a textual representation, a binary representation, and a representation stored in a database.

9. The system of claim 1, the at least one processor further to execute the instructions to receive the query via one of a web application programming interface (API) and a local API.

10. The system of claim 1, wherein the response to the query comprises a term comprising at least one of at least one word, a value, and metadata.

11. The system of claim 1, wherein at least one term has a nested term within.

12. The system of claim 1, wherein the plurality of information banks comprise a number of information banks from information bank 1 to information bank n.

13. The system of claim 12, further comprising fusing the plurality of information banks to create the three-dimensional representation.

14. The system of claim 13, wherein the three-dimensional representation comprises a plurality of three-dimensional data blocks.

15. The system of claim 1, wherein an instance of data in the plurality of information banks is associated with at least one other instance of data using a symmetrical binding.

16. The system of claim 1, wherein an instance of data in the plurality of information banks is associated with at least one other instance of data using one of a fixed anchor, a movable anchor, and a cascading anchor.

17. The system of claim 1, wherein the plurality of information banks comprises a plurality of data layers.

18. The system of claim 1, wherein the format comprises an object representation of a declaration comprising an identifier, a primary value, and at least one metadata key-value pair.

19. The system of claim 1, the at least one processor further to receive the query in a language formatted for the system.

20. A method, comprising:
receiving, by at least one processor, a query comprising one or more words having a particular sequence;
determining, by the at least one processor, a three-dimensional representation of available information associated with the query based on a plurality of information banks, each information bank comprising a layer of available information associated with the query;
evaluating, by the at least one processor, the query using the three-dimensional representation of available information associated with the query, the three-dimensional representation of available information having a plurality of terms, each term comprising an identifier, a value, and zero or more related terms;
generating, by the at least one processor, a response to the query using the three-dimensional representation of available information; and
converting, by the at least one processor, the response to the query into a format for storage.

21. A non-transitory computer-readable storage medium, having instructions stored thereon that, when executed by a computing device cause the computing device to perform operations, the operations comprising:
receiving a query comprising one or more words having a particular sequence;
determining a three-dimensional representation of available information associated with the query based on a plurality of information banks, each information bank comprising a layer of available information associated with the query;
evaluating the query using the three-dimensional representation of available information associated with the query, the three-dimensional representation of available information having a plurality of terms, each term comprising an identifier, a value, and zero or more related terms;
generating a response to the query using the three-dimensional representation of available information; and
converting the response to the query into a format for storage.
